(19) United States
(12) Patent Application Publication
(10) Pub. No.: US 2026/0289194 A1
(43) Pub. Date: Sep. 24, 2026

(54) SYSTEM

(71) Applicant: SoftBank Group Corp., Tokyo (JP)

(72) Inventor: Kazuki DOI, Tokyo (JP)

(73) Assignee: SoftBank Group Corp., Tokyo (JP)

(21) Appl. No.: 19/555,947

(22) Filed: Mar. 4, 2026

(30) Foreign Application Priority Data
Mar. 19, 2025 (JP) 2025-044498

(51) Int. Cl. G06F 40/58; G06F 40/166; G06F 40/20; G06N 3/0475

(52) U.S. Cl. CPC G06F 40/58; G06F 40/166; G06F 40/20; G06N 3/0475

(57) ABSTRACT

A system includes a processor that is configured to analyze input content by using a prompt for instructing a generative AI model to perform translation in order to generate information for foreign users and to perform an appropriate translation based on the analysis, analyze input content by using a prompt for instructing the generative AI model to perform translation in order to generate disaster prevention information and to perform an appropriate translation based on the analysis, and select information sources with high reliability and categorize the selected information sources by using a prompt for instructing the generative AI model to analyze evaluation criteria of the information sources and by causing the generative AI model to analyze the information sources based on the evaluation criteria.

### CROSS-REFERENCE TO RELATED APPLICATION

This application is based on and claims priority under 35 USC 119 from Japanese Patent Application No. 2025-044498 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, information services for foreign users have increasingly relied on machine translation and various automated tools. However, conventional systems generally perform direct translation of text without sufficiently considering the specific needs of foreign users, such as cultural context, language proficiency, and the urgency or criticality of information. As a result, translations for foreign users, including daily information and news, may be difficult to understand, incomplete, or misleading.

In particular, disaster prevention information is often generated and distributed only in the local language, and conventional translation systems simply convert such information in a literal manner. Accordingly, there is a risk that foreign users may not correctly understand the content and seriousness of disaster alerts, emergency instructions, or safety guidelines. This may lead to delays in appropriate actions and an increase in safety-related risks.

Furthermore, in an environment where a vast amount of information is available on the internet, it is difficult for foreign users to identify reliable information sources. Conventional systems do not sufficiently analyze evaluation criteria for information sources, and therefore cannot automatically select and categorize highly reliable sources in a manner tailored to foreign users. Consequently, foreign users may depend on scattered and inconsistent information, leading to confusion or misinformation.

Still further, conventional question-and-answer systems for foreign users mostly rely on fixed rules, pre-registered FAQs, or simple keyword matching. Such systems are not capable of flexibly analyzing question content in natural language and generating contextually appropriate answers. As a result, users may receive answers that are too general, irrelevant, or not adapted to their specific circumstances.

Moreover, existing systems rarely take into account the emotional state of users when presenting information. When a user is anxious, confused, or distressed, for example during disasters or emergencies, conventional systems provide the same type of information as in normal situations. This lack of emotional adaptation can reduce the usability and trustworthiness of the service and may fail to provide adequate psychological support or reassurance.

Accordingly, there is a need for a system that can: (i) generate appropriate translations for foreign users, including disaster prevention information, by effectively utilizing a generative AI model; (ii) analyze and categorize reliable information sources based on explicit evaluation criteria using a generative AI model; (iii) analyze user questions and generate appropriate answers; and (iv) analyze user emotions and provide information corresponding to the emotional state, thereby improving safety, usability, and reliability for foreign users.

### SUMMARY

In order to solve at least part of the above-described problems, an embodiment of the present invention provides a system comprising a processor, wherein the processor is configured to control a generative AI model by using prompts and to perform various analyses and generation processes for foreign users.

According to one aspect of the present invention, there is provided a system comprising a processor, wherein the processor is configured to analyze input content by using a prompt for instructing a generative AI model to perform translation in order to generate information for foreign users and to perform an appropriate translation based on the analysis. In this manner, the processor can cause the generative AI model to generate foreign-language information that is adapted to the comprehension level and context of foreign users, rather than merely performing literal translation.

In addition, the processor is configured to analyze input content by using a prompt for instructing the generative AI model to perform translation in order to generate disaster prevention information and to perform an appropriate translation based on the analysis. By doing so, the processor can cause the generative AI model to produce disaster prevention information in a foreign language in a form that is easy to understand for foreign users, including the addition or clarification of critical safety instructions, thereby improving the safety and responsiveness of foreign users during disasters.

Further, the processor is configured to select information sources with high reliability and categorize the selected information sources by using a prompt for instructing the generative AI model to analyze evaluation criteria of the information sources and by causing the generative AI model to analyze the information sources based on the evaluation criteria. As a result, the system can automatically evaluate and classify information sources, such as websites and databases, according to reliability, relevance, and suitability for foreign users, and can provide categorized lists of high-quality information sources.

In one embodiment, the processor is additionally configured to analyze a question by using a prompt for instructing the generative AI model to analyze content of the question and to generate an answer, in order to generate an appropriate answer to the question. This allows the processor to cause the generative AI model to understand natural language questions from foreign users and to generate contextually appropriate, detailed answers that address the specific intent and circumstances of the users.

In another embodiment, the processor is further configured to analyze an emotion of a user by using a prompt for instructing the generative AI model to analyze an input of the user, and to provide information corresponding to the emotion based on a result of the analysis. By analyzing the user's emotional state, such as anxiety, confusion, or calmness, from textual input or other interaction data, the processor can cause the generative AI model to adjust the content, tone, and detail level of the provided information, thereby offering emotionally adaptive support.

Through the combination of these functions, the system according to the present invention can generate translations and disaster prevention information that are more understandable and actionable for foreign users, can provide curated and categorized reliable information sources, can offer accurate and context-aware answers to user questions, and can supply information adapted to the emotional state of the user. Thus, the invention improves the safety, usability, and reliability of information services for foreign users.

The term “system” refers to an integrated arrangement of hardware and software components, including at least one processor and memory, that cooperatively execute programmed instructions to perform the functions described in the claims.

The term “processor” refers to one or more processing units, such as a central processing unit (CPU), a graphics processing unit (GPU), a digital signal processor (DSP), or any combination thereof, that execute instructions to perform data processing and control operations of the system.

The term “generative AI model” refers to a machine learning model, such as a large language model or similar neural network, that is configured to generate output data including natural language text based on input data and learned parameters.

The term “prompt” refers to information, including text or structured data, provided to the generative AI model as an instruction or context to control or guide the behavior and output of the generative AI model.

The term “input content” refers to any data, including text, symbols, or structured information, that is supplied to the system by a user or an external source and that is subject to analysis or translation by the processor.

The term “translation” refers to a process of converting text or content expressed in a first language into text or content expressed in a second language, and may include adaptation, simplification, or clarification of the original content.

The term “information for foreign users” refers to information that is generated or translated into one or more languages different from the primary local language and that is intended to be easily understood by users who are not native speakers of the primary local language. The term “disaster prevention information” refers to information relating to natural or man-made disasters, including alerts, warnings, status updates, safety instructions, evacuation guidance, and preventive measures intended to protect people and property.

The term “information source” refers to any origin of information, including a website, database, document, feed, or other data repository, from which content is obtained for evaluation, selection, or categorization by the system.

The term “reliability” refers to a measure of trustworthiness or quality of an information source, determined based on criteria such as accuracy, authority, timeliness, consistency, and reputation.

The term “evaluation criteria of the information sources” refers to one or more rules, metrics, or standards used to assess the reliability, relevance, or suitability of information sources for use by the system.

The term “categorize” refers to classifying information sources or generated information into one or more groups or categories based on attributes such as topic, reliability, language, or intended use.

The term “question” refers to a user-provided inquiry expressed in natural language or structured form, requesting information, explanation, or guidance regarding a particular subject.

The term “answer” refers to a response generated by the system, using the generative AI model, that provides information, explanation, or guidance corresponding to at least part of the content or intent of a question.

The term “emotion of a user” refers to an estimated emotional state of the user, such as anxiety, confusion, calmness, satisfaction, or other affective conditions, inferred from user input or interaction with the system.

The term “user input” refers to data provided by a user to the system, including but not limited to text, voice-transcribed text, selections, or other interaction data that can be analyzed by the generative AI model.

The term “information corresponding to the emotion” refers to information whose content, tone, level of detail, or presentation is adapted based on the analyzed emotional state of the user, such as providing reassuring explanations when the user is anxious.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

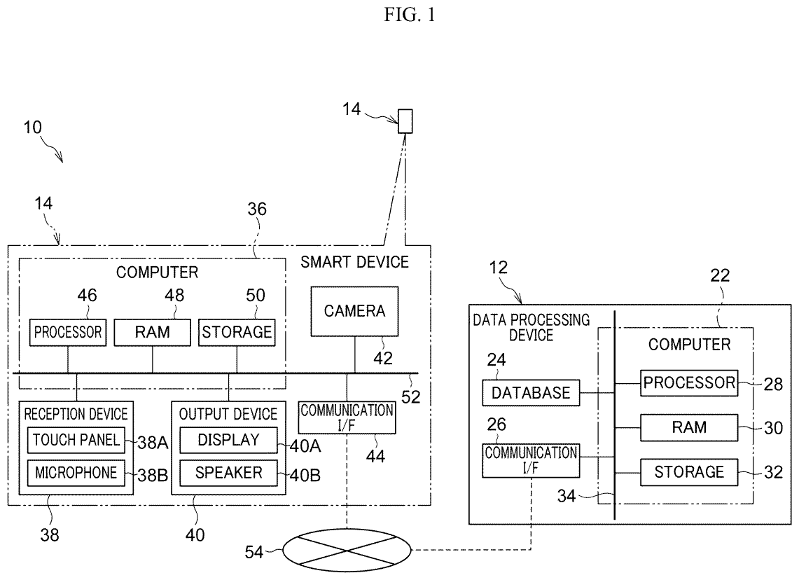

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

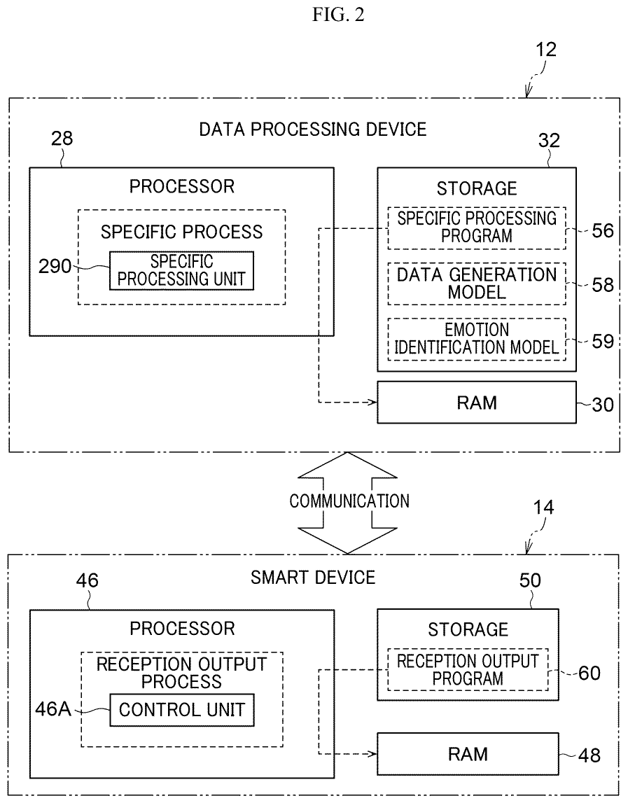

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information-provision systems for foreign-language users mainly rely on static translation pipelines and rule-based content selection. A typical architecture collects source texts from network resources, calls a separate translation service, and then displays translated snippets on a terminal. Such systems suffer from several technical limitations in terms of computer technology.

First, existing systems generally treat translation, source selection, and question answering as independent processes. A translation engine processes input text without coordinated use of contextual data such as prior retrieved documents, source reliability, or user intent. As a result, the system cannot efficiently reuse intermediate data structures, and must repeatedly fetch, translate, and filter large volumes of data, increasing network traffic, storage load, and processor cycles.

Second, conventional architectures do not systematically encode evaluation criteria or classification criteria for information-providing sources in a machine-consumable form that can be used inside a generative AI model. The server usually performs simple keyword filters or static whitelists. This causes technically suboptimal data flows in which the server has no unified metadata layer for reliability scores and category labels, and cannot dynamically route queries or generate answers based on structured reliability information. This lack of structured metadata leads to inefficient query planning, redundant database accesses, and suboptimal utilization of processor and memory resources.

Third, conventional systems do not integrate question answering and emotion analysis into a single, prompt-driven control layer. Question answering engines are often separated from sentiment or emotion analyzers, each invoked through its own application programming interface. This fragmented design prevents the server from forming a single coherent prompt sentence that includes context information, reliability metadata, and user emotion information. Consequently, the server cannot effectively coordinate the generative AI model's computation, and must perform multiple independent inference calls, which increases response latency, consumes excessive computation resources in the remote model, and complicates error handling and caching strategies.

Fourth, previous solutions rarely exploit a structured “prompt orchestration” mechanism, in which the server programmatically builds prompt sentences that embed: (i) translated context texts, (ii) reliability scores and category metadata for information-providing sources, and (iii) user-specific parameters such as target language and emotional state. Without such orchestration, the server cannot optimize its internal data structures and network payloads for the generative AI model. The absence of this mechanism leads to oversized or poorly structured requests, inefficient use of bandwidth and processing resources, and less predictable runtime behavior.

Therefore, there is a need for an improved computer-implemented system and server architecture that (a) tightly integrates acquisition, translation, reliability evaluation, categorization, question answering, and emotion analysis, and (b) programmatically generates prompt sentences for a generative AI model using structured metadata and context, so as to reduce redundant processing, improve consistency of responses, and enhance the overall efficiency and technical performance of the information-provision pipeline.

The specific processing by the specific processing unit 290 of the data processing device 12 in Example 1 is realized by the following means.

The present invention provides a server comprising a processor configured to acquire, via a communication network, original text information including news information or disaster-prevention information from a plurality of information-providing sources and to store the acquired original text information as structured data in a storage device, to use translation software or an external translation service to convert character-string data in a first language included in the original text information into character-string data in at least one second language and to store the converted character-string data in association with the original text information, to generate, as an input sentence for a generative AI model, a prompt sentence including evaluation criteria and classification criteria for the information-providing sources, to transmit the input sentence to the generative AI model, to receive an analysis result from the generative AI model, to calculate a reliability value of each information-providing source based on the analysis result, and to classify each information-providing source into a higher-level concept category and store a classification result as metadata, to transmit, in response to a use request received from a user terminal, response data formatted according to a communication protocol, the response data including the character-string data in the at least one second language and information on the information-providing sources with the reliability value and the category, to generate, as another input sentence for the generative AI model, a prompt sentence instructing the generative AI model to perform question analysis and answer generation based on a user input sentence received from the user terminal, the original text information, and the metadata including the reliability value and the category, to transmit the other input sentence to the generative AI model, to receive an answer sentence from the generative AI model, and to format the answer sentence as response data for the user terminal, and to generate, as still another input sentence for the generative AI model, a prompt sentence instructing the generative AI model to perform emotion analysis based on the user input sentence, to transmit the still other input sentence to the generative AI model, to receive an emotion analysis result, and to control content or an expression format of the response data based on the emotion analysis result. This enables an integrated, prompt-driven control flow in which the server builds structured prompt sentences embedding translated context, reliability and category metadata, and user emotion information, thereby reducing redundant network calls and translation operations, improving the efficiency of memory and processor usage in the server and the generative AI model, and enhancing the consistency, responsiveness, and technical performance of the computer-implemented information-provision system.

The term “server” refers to an information processing apparatus including at least one processor and at least one storage device, configured to execute programs for acquiring, storing, processing, and transmitting data via a communication network.

The term “processor” refers to a hardware computing element, such as a central processing unit or other processing circuitry, that is configured to execute instructions of a program and to control operations of components of a system.

The term “storage device” refers to a non-transitory computer-readable medium, such as a semiconductor memory, magnetic storage, or optical storage, configured to store programs, data, and metadata used by the processor.

The term “communication network” refers to any wired or wireless data communication infrastructure, including at least one of a local area network, a wide area network, and a public packet-switched network, through which the server exchanges data with external devices.

The term “user terminal” refers to an electronic device operated by a user, such as a personal computer, a smartphone, or a tablet device, configured to transmit a use request and a user input sentence to the server and to receive and display response data from the server.

The term “original text information” refers to information items acquired from information-providing sources via the communication network, the information items including at least text data in a first language and representing news information, disaster-prevention information, or other informational content.

The term “structured data” refers to data stored in a format having a predefined schema, such as records including fields for a title, a body text, a date, and a source identifier, which can be processed by the processor using deterministic data structures.

The term “first language” refers to a natural language of the original text information as acquired from the information-providing sources, such as a domestic language in which news information or disaster-prevention information is primarily published.

The term “second language” refers to a natural language into which character-string data of the original text information is translated for a foreign-language user, and may include one or more target languages different from the first language.

The term “character-string data” refers to text data composed of a sequence of characters, symbols, or code points representing linguistic content in a particular language.

The term “information-providing source” refers to an external provider of information accessible via the communication network, such as a network site, a data feed, or an information service endpoint, from which the server acquires original text information.

The term “translation software” refers to a software component or program executed by the processor or by another computing resource, configured to convert character-string data from the first language to the second language according to machine translation logic.

The term “external translation service” refers to a remotely hosted translation processing service accessible via the communication network, which receives character-string data in the first language and returns character-string data in the second language.

The term “generative AI model” refers to a machine-learning model, implemented on one or more computing resources, configured to generate text or other output data in response to an input sentence including at least a prompt sentence and optional context data.

The term “prompt sentence” refers to a portion of an input sentence transmitted to the generative AI model, the portion including instructions, conditions, or criteria specifying how the generative AI model is to analyze input data and generate output data.

The term “input sentence” refers to a structured textual input provided to the generative AI model, including at least one prompt sentence and optionally including context information, metadata, or user-specific parameters.

The term “analysis result” refers to output data generated by the generative AI model in response to an input sentence, the output data including at least evaluations, classifications, or other inferred information about the input data.

The term “reliability value” refers to a numerical or otherwise quantifiable measure indicating a degree of trustworthiness of an information-providing source, calculated based on the analysis result generated by the generative AI model.

The term “higher-level concept category” refers to a classification label representing a generalized topic or domain, such as a disaster-prevention category, a health category, or an education category, to which an information-providing source or content item is assigned.

The term “metadata” refers to auxiliary data associated with original text information or an information-providing source, including at least a reliability value and category information, and used by the processor in generating prompt sentences and response data.

The term “use request” refers to a request transmitted from the user terminal to the server, the request specifying at least a desired operation such as acquisition of translated information, retrieval of categorized sources, or generation of an answer sentence.

The term “response data” refers to data generated by the server and transmitted to the user terminal in response to a use request, the data being formatted according to a communication protocol and including at least translated character-string data and/or an answer sentence.

The term “communication protocol” refers to a set of rules and message formats, including at least an application-layer protocol, that defines how the server and the user terminal exchange request and response data via the communication network.

The term “user input sentence” refers to textual input data provided by a user through the user terminal, the input data including at least a question, a request, or a message expressing an information need or an emotional state.

The term “question analysis” refers to processing performed by the generative AI model or by the processor to interpret the content of a user input sentence, identify an intent or topic, and determine relevant context information for generating an answer sentence.

The term “answer generation” refers to processing performed by the generative AI model to produce an answer sentence based on the user input sentence, context information, and metadata included in the input sentence.

The term “answer sentence” refers to text data generated by the generative AI model as a response to a user input sentence, which the processor formats and includes in response data for the user terminal.

The term “emotion analysis” refers to processing performed by the generative AI model to infer an emotional state, attitude, or sentiment from the user input sentence, and to output an emotion analysis result representing the inferred state.

The term “emotion analysis result” refers to output data generated by the generative AI model in response to the emotion analysis prompt sentence, the output data including at least one indicator of an emotional state associated with the user input sentence.

The term “context information” refers to information, including at least original text information and translated character-string data selected as candidate information related to a use request, that is embedded in an input sentence to guide the generative AI model.

The term “candidate information” refers to one or more items of original text information or translated information that are selected by the processor as being related to a current use request and suitable for inclusion as context information in a prompt sentence.

The term “reference information” refers to information embedded in an answer sentence or response data, including at least identifiers, links, or summaries of information-providing sources, enabling a user or another system to refer to those sources.

The term “category information” refers to data indicating one or more higher-level concept categories assigned to an information-providing source or to content, and used by the processor and the generative AI model in classification and answer generation.

The term “use request-related category” refers to a higher-level concept category determined by the processor to correspond to the topic or intent expressed in a use request, and used to select relevant information-providing sources and context information.

In one embodiment, a server executes a program on a processor to implement an integrated information-provision system for foreign-language users. The server is connected to a communication network and to one or more storage devices, and the server communicates with a terminal operated by a user. The server executes an operating system such as a general-purpose server operating system (for example, a UNIX-based or Linux-based system) and runs application software implemented, for example, using a web application framework and a database management system such as a relational database. The terminal executes a client application implemented, for example, as a native mobile application or a web browser application.

The server acquires original text information from information-providing sources distributed across the network. The server uses communication software such as an HTTP client library to send network requests to endpoints associated with news feeds, governmental disaster-prevention portals, and other public information services. The server receives response data in formats such as HTML, XML, or JSON and parses the response data using parsing software such as an HTML parser or an XML parser. The server converts the parsed data into structured records, each record including fields such as a source identifier, a title, a body text, a publication time, a language code, and a content type. The server stores the structured records in the storage device using a data schema designed for efficient retrieval by topic, language, and source reliability.

The server uses translation software or an external translation service to convert character-string data from a first language to at least one second language. The server identifies, for each record, text fields that require translation, such as the title and the body text. The server batches multiple text segments into a translation request to reduce communication overhead.

The server sends the batched request to a translation engine running either locally or on a remote machine. The translation engine uses a neural-machine-translation model such as an encoder-decoder architecture with attention, trained on parallel corpora, to generate translated text. The server receives translated text segments and writes them into corresponding fields in a translation table in the storage device, linking each translated segment to a primary key of the original record. By associating original and translated text at the database level, the server improves cache reuse and avoids redundant translation of previously processed content.

The server maintains metadata describing information-providing sources, including a reliability value and one or more higher-level concept categories. The server uses a generative AI model deployed on a remote inference service to derive these metadata values.

The server constructs a prompt sentence that encodes evaluation criteria and classification criteria. For example, the server generates a prompt sentence such as:

“You are a system that evaluates the reliability of information websites for foreign-language residents.

For each site, estimate its reliability for official news and disaster-prevention information on a scale from 0.0 to 1.0.

Assign one or more categories from: [‘Disaster Prevention’, ‘Health’, ‘Education’, ‘Daily Life’, ‘Immigration’].

Output the result in a structured textual form, including: url, reliability_score, categories, and a one-sentence explanation.”

The server embeds, after this prompt sentence, textual descriptions and URLs of candidate information-providing sources. The server sends the input sentence to the generative AI model via a network interface using a standardized application programming interface. The generative AI model includes, for example, a transformer-based neural network comprising multiple self-attention layers, feedforward layers, and layer-normalization units, trained on large-scale text data using a language-modeling objective function that minimizes a cross-entropy loss between predicted tokens and ground-truth tokens. The generative AI model outputs an analysis result containing, for each site, a reliability indication and category labels. The server parses the analysis result, converts the output into numerical reliability values and symbolic category identifiers, and stores these values as metadata in the storage device. Because the generative AI model internally applies attention weights across tokens, the model can jointly consider domain cues, governmental terms, and stability of publishing patterns in a manner that is not achievable by simple rule-based filters, thereby enabling more granular reliability estimation.

The server also uses the generative AI model for question analysis and answer generation. The terminal receives a user input sentence such as a question about disaster-prevention procedures or living conditions. The terminal sends the user input sentence and associated parameters, including a requested language and an optional topic filter, to the server through the communication network. The server receives the user input sentence, performs preprocessing such as language detection and tokenization, and retrieves candidate information from the structured records and metadata. The server selects, for example, a set of documents that match the topic and that originate from sources having a reliability value above a predetermined threshold. The server constructs context information by concatenating summaries of these documents and attaching source identifiers.

The server generates a prompt sentence for question answering, such as:
“You are an assistant for foreign-language residents.
Answer in clear and simple [target language].
Use only the following context information and metadata about source reliability and category.
If some required information is not contained in the context, explicitly state that it is not covered.
Provide a concise, step-by-step answer.”

The server appends to this prompt sentence the user input sentence, the context information, and metadata including reliability values and categories. The server transmits the combined input sentence to the generative AI model. The generative AI model, using its transformer layers, computes contextual representations for each token, attends to portions of the context associated with high-reliability sources, and generates an answer sentence token by token. The server receives the answer sentence, verifies that it is in the target language, optionally normalizes punctuation and length, and then forms response data to send back to the terminal. The server further uses the generative AI model to perform emotion analysis. When the server receives a user input sentence that may embed emotional expressions, the server generates a dedicated prompt sentence such as:
“You analyze the emotional state of a foreign-language user based on the following input. Classify the main emotion among: [‘calm’, ‘worried’, ‘afraid’, ‘confused’, ‘angry’]. Provide a short explanation for your classification.”

The server appends the user input sentence and transmits the combined input sentence to the generative AI model. The model encodes the text and compares the internal representations to patterns correlated with emotional categories learned during training. The model outputs an emotion analysis result including one or more emotional labels and a short justification. The server parses this result, converts the emotional labels into symbolic codes, and uses these codes to select an information template or wording style. For example, the server may select a more reassuring tone and additional explanatory detail when the emotional code indicates that the user is worried or afraid. By systematically encoding the emotion analysis into discrete control variables, the server changes not only the wording but also the selection of contextual documents, thereby technically altering cache usage, memory allocation, and network bandwidth requirements based on the emotional state.

The server executes these operations using distinct modules and data structures that improve technical performance. The server maintains a source table containing a source identifier, base URL, last-update time, and cached reliability metadata. The server maintains a document table containing document identifiers, source identifiers, language codes, token counts, and embedding references. The server maintains a translation table keyed by document identifier and language code. The server also maintains an index structure, such as an inverted index, for fast retrieval of documents by topic. The server stores generative-model interaction logs, including prompt sentences, context snippets, and response summaries, in a separate log table to enable reuse and caching of frequent query patterns. The server applies an orchestration algorithm that determines, for each user request, how to construct an input sentence for the generative AI model. The orchestration algorithm uses a non-trivial sequence of operations, including selection of candidate documents based on reliability thresholds and topic matches, truncation of context based on maximum token length of the generative AI model, and insertion of metadata in a canonical order. For example, the server first sorts candidate documents by reliability value, then selects the top-k documents whose combined token count does not exceed a predetermined limit, and then inserts, for each selected document, a link between a source identifier and a category label into the context. This orchestration reduces the token count sent to the generative AI model, which directly reduces network bandwidth and inference time while maintaining high answer quality by prioritizing high-reliability sources.

The generative AI model used by the server is, for example, a transformer architecture with an input embedding layer, sinusoidal or learned positional encodings, multiple self-attention blocks, and a final linear layer projecting to a vocabulary distribution. During its initial training, the model minimizes a cross-entropy loss over large text corpora. During fine-tuning for reliability evaluation or question answering, the model may use supervised learning where label data for reliability scores or answer correctness are available. The training process updates weight matrices using a stochastic gradient-based optimization algorithm such as Adam, and may incorporate techniques such as dropout, layer normalization, and learning-rate scheduling. The server does not perform training itself during normal user operations, but the server uses the trained parameters to perform deterministic inference given a fixed input sentence, which ensures reproducible behavior and predictable computational load.

The server can operate with different generative AI models and translation engines. In one variation, the server uses a locally hosted language model for sensitive data, and a remotely hosted model for less sensitive queries, dynamically selecting the backend based on classification of the user input sentence. In another variation, the server uses a domain-adapted language model whose vocabulary and attention weights are specialized for disaster-prevention terminology, thereby reducing perplexity for relevant queries and improving answer precision. The server can also change the internal thresholds for reliability values or token budgets to tune the trade-off between computation cost and answer detail.

The terminal displays the response data using a graphical user interface. The terminal parses received text, allocates display buffers, and renders components such as lists of documents, answer paragraphs, and icons indicating reliability. The terminal may locally store a subset of the response data to allow offline viewing. The terminal may also send user feedback, such as ratings for helpfulness or correctness, back to the server. The server aggregates such feedback and may, in some embodiments, use it as additional data to adjust reliability values or to retrain auxiliary models.

The system improves computer technology in several ways. Because the server uses structured metadata (reliability values, category labels, emotional codes) in combination with a prompt-orchestration algorithm, the server reduces redundant network calls to the generative AI model and translation services. The server sends only high-priority context information and encoded metadata, which reduces average input length and computation time, and therefore lowers server-side and remote-model resource usage. The server's use of reliability-aware and category-aware indexing enables faster retrieval and more targeted caching, reducing database query time. The emotion-aware control of content selection and formatting not only improves user experience but also leads to more stable traffic patterns because the server can, for example, avoid sending unnecessarily long explanations when the user is calm and only needs concise updates.

Furthermore, the system does not merely automate human translation or summarization work. The system implements non-conventional data flows and control logic that cannot reasonably be executed by a human in real time, such as dynamically recomputing reliability-weighted document sets, constructing prompt sentences with explicit constraints on token budgets, and coordinating translation, reliability evaluation, and emotion analysis at the scale of thousands of documents across multiple languages. The cause-and-effect relationship is clear: by encoding reliability and category information as metadata and embedding the metadata in prompt sentences, the server guides the generative AI model to focus on high-quality sources and relevant domains, which in turn reduces hallucinated or irrelevant content, thereby lowering the rate of erroneous answers and improving overall accuracy. At the same time, by performing context truncation and selection based on token-length limits and reliability ranking, the server shortens inference time and reduces memory consumption, directly improving processing speed and scalability.

Alternative embodiments are possible. In one embodiment, the server uses a combination of a generative AI model and a non-neural classifier. The server first applies a lightweight classifier, such as a gradient-boosted tree model, to quickly filter out low-reliability sources based on structural features (e.g., domain age, TLS status, response time), and then sends remaining candidates to the generative AI model for fine-grained textual evaluation via prompt sentences. In another embodiment, the server precomputes vector embeddings of documents and stores them in a vector index structure, and the server uses similarity search to select context information before constructing prompt sentences. These configurations further decrease latency and improve answer relevance by limiting the search space while retaining the ability of the generative AI model to perform nuanced reasoning over the selected context.

In each embodiment, the server, the terminal, and the generative AI model cooperate through specifically designed data structures and prompt sentences. The system as a whole thereby implements a concrete improvement to computer operation, including improved use of network resources, optimized database access patterns, and more efficient and accurate text generation, beyond a mere automation of manual translation or lookup tasks.

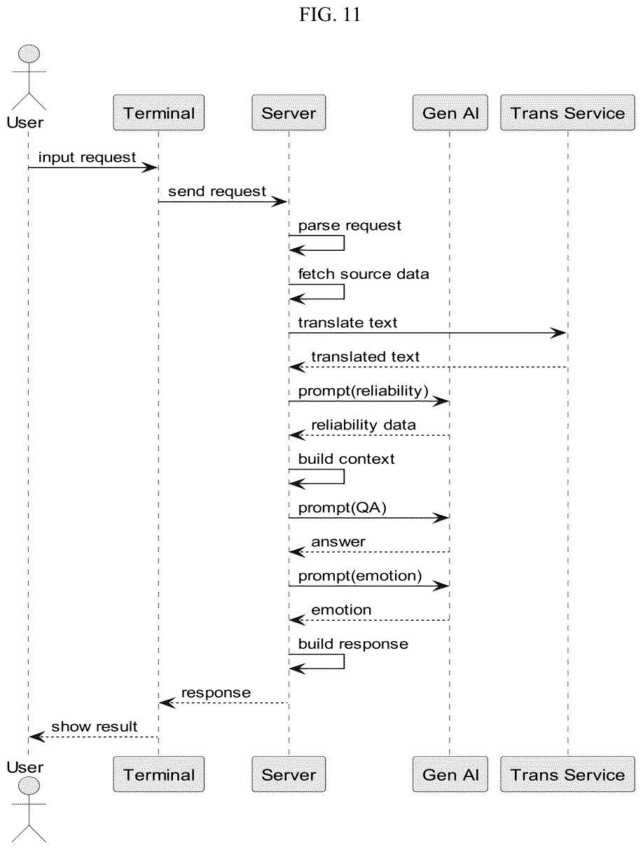

The following describes the processing flow using FIG. 11.

### Step 1:

The user operates the terminal to input a request.

The user selects a function on the terminal, such as viewing news, checking disaster-prevention information, or asking a question, and then enters a natural-language sentence (for example, “I want the latest earthquake information in English”). The terminal receives the user's text input and UI selections (language, topic) as input. The terminal combines these items into a structured internal object, and the terminal outputs a request payload containing at least the user input sentence, a request type, and a target language.

### Step 2:

The terminal transmits the request payload to the server.

The terminal uses a communication library to send the request payload via a communication network using a protocol such as HTTPS. The input to this step is the structured request payload generated in Step 1. The terminal encapsulates the payload into an HTTP message, establishes a secure connection with the server, and outputs a network request that reaches the server's network interface.

### Step 3:

The server receives and parses the request payload.

The server accepts the incoming network request as input. The server terminates the secure channel, extracts the message body, and parses the payload using a JSON or similar parser. The server performs validation on fields such as request type, target language, and user identifier. Based on the parsed content, the server outputs an internal control structure that expresses the operation to be performed (for example, news retrieval, question answering, or emotion analysis) and the associated parameters.

### Step 4:

The server acquires original text information from information-providing sources.

The server uses the internal control structure and stored configuration data (for example, a list of source URLs) as input. The server sends network requests to multiple information-providing sources, such as news feeds and disaster-prevention portals, using an HTTP client. The server receives response data, parses HTML, XML, or JSON, and performs data extraction to obtain fields such as title, body text, publication time, and source identifier. The server converts the extracted data into structured records and outputs a set of original text information entries stored in a database or memory.

### Step 5:

The server selects and prepares text segments for translation.

The server uses the set of original text information entries and the target language specified in the request as input. The server determines which entries require translation based on language codes and cache status, and extracts text fields (titles and body texts) as character strings. The server groups multiple character strings into batches to optimize translation calls, calculates the total character length for each batch, and outputs a batched translation request object containing the character-string data and language conversion parameters.

### Step 6:

The server converts the original text information into translated text.

The server uses the batched translation request object as input. The server calls translation software or an external translation service, transmitting the first-language character strings and the target language code. The translation engine performs neural-machine-translation processing and returns corresponding character strings in at least one second language. The server receives the translated text segments, aligns each translated segment with the original record identifier, and outputs updated records in which each original entry is associated with translated character-string data.

### Step 7:

The server evaluates and categorizes information-providing sources using a generative AI model.

The server uses source metadata (such as URLs, source names, previous reliability values) and descriptions of the sources as input. The server constructs a prompt sentence describing evaluation criteria and classification criteria, and the server concatenates this prompt sentence with textual descriptions of candidate sources to form an input sentence. The server transmits the input sentence to the generative AI model. The generative AI model applies its neural-network computation to derive reliability and category suggestions, and returns an analysis result. The server parses the analysis result, converts reliability expressions into numerical reliability values, maps textual categories to internal category codes, and outputs updated metadata for each information-providing source stored in the database.

### Step 8:

The server retrieves context information and metadata for question answering.

The server uses the parsed request payload and the stored records and metadata as input. If the request type indicates question answering, the server retrieves documents and metadata that are relevant to the user's question, for example, documents whose topic or keywords match the question and whose reliability value exceeds a threshold. The server ranks candidate documents by reliability and recency, truncates the set according to a token-length budget, and constructs context information consisting of document summaries, source identifiers, and category labels. The server outputs a compact context package that will be embedded in a prompt sentence.

### Step 9:

The server generates a prompt sentence for question analysis and answer generation.

The server uses the user input sentence and the context package as input. The server creates a prompt sentence including instructions for language, style, and allowed information sources, for example:
“You are an assistant for foreign-language residents.
Answer in clear and simple [target language].
Use only the following context information and metadata about source reliability and category.
If some required information is not contained in the context, explicitly state that it is not covered.
Provide a concise, step-by-step answer.”

The server appends the user input sentence and the context information after this prompt sentence, forming a combined input sentence for the generative AI model. The server outputs this combined input sentence as a model-request object.

### Step 10:

The server obtains an answer sentence from the generative AI model.

The server uses the model-request object as input. The server sends the combined input sentence to the generative AI model over the communication network. The generative AI model executes internal transformer computations to generate an answer sentence conditioned on the prompt sentence and context information. The server receives the model output, extracts the answer text, and performs post-processing such as verifying language, limiting length, and normalizing formatting. The server outputs a finalized answer sentence ready to be returned to the terminal.

### Step 11:

The server performs emotion analysis based on the user input sentence.

The server uses the original user input sentence as input for an emotion analysis operation.

The server generates a specialized prompt sentence, for example:

“You analyze the emotional state of a foreign-language user based on the following input. Classify the main emotion among: [‘calm’, ‘worried’, ‘afraid’, ‘confused’, ‘angry’]. Provide a short explanation for your classification.”

The server appends the user input sentence and creates an emotion-analysis input sentence.

The server transmits this input sentence to the generative AI model, receives an emotion analysis result, and parses labels and explanations. Based on these labels, the server determines control parameters for tone and detail level and outputs an emotion code and an associated explanation string.

### Step 12:

The server formats response data for the terminal.

The server uses the translated records, the answer sentence, the reliability metadata, the category information, and the emotion code as input. The server selects which translated items to include (for example, the top-ranked news articles) and determines the presentation format and level of detail according to the emotion code and request type. The server constructs response data that contains, as fields, translated character strings, the answer sentence, references to high-reliability sources, and optional explanations of source reliability. The server serializes this data into a structured message format (for example, JSON) and outputs a protocol-compliant response to be sent to the terminal.

Step 13:

The terminal receives and renders the response data.

The terminal uses the protocol-compliant response from the server as input. The terminal parses the structured message, extracts translated text, answer sentences, and source references, and allocates user-interface components to display these items. The terminal renders lists of articles, detailed views of selected items, and text-based answers, and may display icons or labels indicating reliability categories. The terminal outputs graphical or textual content on the display, enabling the user to read the recommended and translated information.

### Step 14:

The user reviews the information and optionally issues additional requests.

The user views the translated content and answer sentences displayed on the terminal as input. Based on this information, the user may decide to ask follow-up questions or request more specific data. The user enters new natural-language queries, such as “Explain what seismic intensity 5 means” or “Show more reliable health information sources,” and the terminal collects these inputs. The terminal outputs new request payloads, which are sent again to the server, thereby causing repetition of the above-described processing flow for subsequent interactions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information provision systems for foreign residents typically rely on static rule-based translation pipelines, fixed templates, and non-contextual notification logic. Such systems suffer from several technical limitations at the computing level.

First, existing systems generally separate language translation, disaster notification, and information retrieval into independent software modules that are not coordinated through a unified control flow. As a result, the systems process incoming data streams (e.g., news feeds, disaster alerts, and web pages) without dynamically adapting translation parameters such as target language, region, information type, and user context. This rigid pipeline causes redundant processing, increased latency, and inefficient use of computing resources because the same source data may be repeatedly translated or delivered to users who do not require it.

Second, many systems rely on fixed translation engines that operate on isolated text segments and do not leverage generative AI models controlled by structured prompt sentences. These systems lack the capability to automatically construct prompts that incorporate contextual information, evaluation indices, emergency parameters, or user preferences, and therefore cannot optimize translation quality, simplification level, or responsiveness for different use cases such as disaster alerts versus cultural explanations. This leads to suboptimal machine translation output and prevents fine-grained control of model behavior within the computing environment.

Third, the selection and organization of information sources are often performed manually or by simple keyword filtering, without using a generative AI model to evaluate and categorize sources based on reliability, relevance, and novelty. This results in low-quality indices and search results, which in turn forces the server and client devices to handle noisy or unreliable content. The absence of an AI-assisted indexing mechanism increases storage overhead, degrades search precision, and complicates retrieval logic in the server software.

Fourth, conventional question-answering components frequently treat user queries in isolation. They do not systematically combine (i) a search over curated source indices with (ii) construction of prompt sentences that encode answer policies, output language, and expression difficulty for a generative AI model. Consequently, the server cannot consistently generate context-aware answers optimized for different language abilities or situational needs, and the computing process for question-answering remains fragmented and inefficient.

Fifth, typical personalization methods are limited to basic recommendation heuristics and do not integrate multi-dimensional behavioral logs (operation history, browsing history, notification responses) with generative AI-driven content selection. Without a unified mechanism to infer user interests and to generate personalized prompt-based workflows, the server cannot efficiently prioritize which translated content or alerts to compute, store, or transmit. This causes unnecessary processing load, network traffic, and client-side UI complexity.

Sixth, existing systems rarely allow users to specify notification conditions, translation conditions, or information acquisition conditions as natural-language prompt sentences that are automatically converted into structured rule information. Without such a mechanism, server-side scheduling and rule-based orchestration of translation, disaster processing, and notification remain limited to preconfigured settings, and the computing architecture cannot easily adapt to diverse or changing user requirements. This also prevents automated, event-driven execution of complex workflows under a unified control logic.

Accordingly, there is a need for an improved computer-implemented system that: (i) integrates acquisition, translation, evaluation, indexing, answering, personalization, and notification processes under a unified server-side control flow; (ii) uses generative AI models driven by dynamically constructed prompt sentences to perform translation, simplification, source evaluation, and question-answer generation; (iii) automatically builds and maintains high-quality indices of information sources; (iv) derives user-specific rules from natural-language prompt sentences; and (v) executes translation and notification operations in an event-driven and resource-efficient manner. Such a system would improve the functioning of the server and the overall computing environment by reducing redundant processing, lowering latency, and enabling more accurate and context-sensitive information delivery to terminal devices.

The specific processing by the specific processing unit 290 of the data processing device 12 in Application Example 1 is realized by the following means.

The present invention provides a server comprising a processor configured to acquire information data in a first language from a plurality of information providing sources via a communication network, normalize the information data as translation-target data, and store the translation-target data in a storage medium; generate translation conditions including at least a target language, a target region, and an information type based on the translation-target data and user attribute data, construct a prompt sentence including the translation conditions as an instruction to a generative AI model, and cause the generative AI model to execute translation processing on the translation-target data to obtain a translation result; determine, for disaster-related information data acquired from disaster-related information providing sources, disaster translation conditions including at least a disaster type, an occurrence region, an urgency level, and a target language, construct a prompt sentence including the disaster translation conditions as an instruction to the generative AI model, and cause the generative AI model to execute translation processing and simplification processing on the disaster-related information data to obtain a disaster translation result; generate evaluation indices indicating at least reliability, relevance, and novelty of the plurality of information providing sources based on structured data relating to the plurality of information providing sources and evaluation criterion data acquired via the communication network, construct a prompt sentence including the evaluation indices and category information as an instruction to the generative AI model, and cause the generative AI model to evaluate the plurality of information providing sources and to select and categorize the plurality of information providing sources according to the reliability, thereby constructing an index database of high-quality information providing sources; select, based on language settings, region settings, and notification settings for each user, at least one of the translation result and the disaster translation result, configure the selected result as notification data, and transmit the notification data to a terminal device via the communication network; receive a search request or a question sentence from the terminal device, extract related content corresponding to the search request or the question sentence from the index database as context information, construct a prompt sentence including the context information and the search request or the question sentence as an instruction to the generative AI model, and cause the generative AI model to generate an answer sentence based on the context information and transmit the answer sentence to the terminal device; analyze operation history data, browsing history data, and notification response history data of a user to extract interest information of the user, select at least one of the translation result, the disaster-related information data, and the high-quality information providing sources based on the interest information, and generate a personalized recommendation information list; and receive, as a natural-language prompt sentence, at least one of notification conditions, translation conditions, and information acquisition conditions input by the user, analyze the prompt sentence to generate structured rule information including at least a language type, an information type, and an execution timing, and, based on the structured rule information, automatically execute, periodically or upon occurrence of an event, at least one of the translation processing, the disaster translation processing, and notification processing. This enables an integrated, prompt-controlled, and context-aware information processing architecture that improves server-side resource utilization, reduces redundant translation and notification operations, and enhances the accuracy, timeliness, and personalization of information delivery to terminal devices within the computing environment.

The term “information data” refers to machine-readable data items including at least textual content, metadata, and identifiers that are obtained from one or more information providing sources and represent news, alerts, guidance, or other informational content.

The term “first language” refers to a source natural language in which information data is originally provided before any translation processing is performed.

The term “information providing source” refers to any network-accessible service, server, database, or content repository that supplies information data, including but not limited to news feeds, disaster alert feeds, and public information portals.

The term “communication network” refers to any wired or wireless data communication infrastructure, including local networks and wide-area networks, that enables data exchange between the server, the information providing sources, and terminal devices.

The term “translation-target data” refers to information data in the first language that has been normalized and structured for use as input to translation processing by a generative AI model or other translation engine.

The term “storage medium” refers to any non-transitory computer-readable medium, such as a memory device, a magnetic disk, or a solid-state storage device, configured to store translation-target data, translation results, rule information, and related data structures.

The term “translation conditions” refers to structured parameter data including at least a target language, a target region, and an information type that are used to control how translation processing is executed for translation-target data.

The term “target language” refers to a natural language into which the translation-target data or disaster-related information data is to be translated by the generative AI model.

The term “target region” refers to a geographic area or jurisdiction associated with a user or an event, used to control selection, translation, and notification of information data.

The term “information type” refers to a classification of information data, such as disaster information, general news, cultural information, or lifestyle guidance, used to determine translation conditions and notification behavior.

The term “user attribute data” refers to data representing characteristics or settings of a user, including at least language preferences, region preferences, notification preferences, and profile identifiers.

The term “prompt sentence” refers to a natural-language or structured textual instruction sequence provided to a generative AI model to specify processing behavior, constraints, or output format.

The term “generative AI model” refers to a machine-learned model, such as a large language model, configured to generate text output including translations, summaries, evaluations, or answers in response to prompt sentences.

The term “translation processing” refers to a computational procedure in which the generative AI model receives translation-target data and a prompt sentence including translation conditions and outputs translated text in a target language.

The term “translation result” refers to output data produced by translation processing, including translated text and optionally associated metadata such as timestamps, confidence scores, and language labels.

The term “disaster-related information data” refers to information data obtained from disaster-related information providing sources and representing events such as earthquakes, storms, floods, or other emergency conditions.

The term “disaster translation conditions” refers to structured parameter data including at least a disaster type, an occurrence region, an urgency level, and a target language used to control translation and simplification of disaster-related information data.

The term “disaster type” refers to a classification of a disaster event, such as an earthquake, typhoon, flood, or fire, used to determine how disaster-related information data is processed and presented.

The term “occurrence region” refers to a geographic area in which a disaster event occurs or is predicted to occur, used to filter and prioritize disaster-related information data.

The term “urgency level” refers to a measure of the time-criticality or severity of disaster-related information data and is used to adjust notification priority and simplification processing.

The term “simplification processing” refers to a procedure in which the generative AI model reformulates technical or complex disaster-related information data into a more understandable form suitable for non-expert users.

The term “evaluation indices” refers to quantitative or qualitative indicators representing at least reliability, relevance, and novelty of information providing sources, derived from structured data and evaluation criterion data.

The term “structured data” refers to data formatted according to a predefined schema, including fields such as identifiers, timestamps, categories, and metrics, which can be programmatically processed by the server.

The term “evaluation criterion data” refers to data defining rules, thresholds, or weights used to compute evaluation indices for information providing sources.

The term “reliability” refers to a measure indicating the trustworthiness or authority of an information providing source based on factors such as origin, consistency, and historical accuracy.

The term “relevance” refers to a measure indicating how closely information data or an information providing source is related to a user's interests, region, or current context.

The term “novelty” refers to a measure indicating how recent or non-duplicative information data is relative to previously stored or delivered content.

The term “category information” refers to data indicating a classification or grouping for information providing sources or content, such as topic categories, disaster categories, or content types.

The term “index database” refers to a data structure or collection of data structures used to store and retrieve indexed representations of high-quality information providing sources and associated metadata.

The term “high-quality information providing source” refers to an information providing source that satisfies predetermined criteria for reliability, relevance, and novelty as determined using evaluation indices and a generative AI model.

The term “language settings” refers to configuration data associated with a user indicating preferred display languages and translation targets.

The term “region settings” refers to configuration data associated with a user indicating geographic areas of interest for receiving information and notifications.

The term “notification settings” refers to configuration data associated with a user specifying conditions under which notifications are to be sent, including frequency, content types, and urgency thresholds.

The term “notification data” refers to data configured for delivery to a terminal device, including at least a portion of a translation result or disaster translation result and associated metadata such as a title or link.

The term “terminal device” refers to any user-operated computing device, such as a smartphone, tablet, or personal computer, configured to communicate with the server over the communication network and to display information.

The term “search request” refers to a request message received from a terminal device specifying search terms, filters, or criteria for retrieving information from the index database.

The term “question sentence” refers to a user-provided textual inquiry requesting information, guidance, or clarification, and intended to be processed by a generative AI model.

The term “context information” refers to content items, passages, or summaries retrieved from the index database or other storage and used as supporting information in prompt sentences for the generative AI model.

The term “answer sentence” refers to a text output generated by the generative AI model in response to a prompt sentence including at least a search request or question sentence and context information.

The term “operation history data” refers to logs representing user interactions with a terminal device or application, such as clicks, taps, scroll events, and command selections.

The term “browsing history data” refers to logs representing content items or pages that a user has viewed or accessed via a terminal device.

The term “notification response history data” refers to logs indicating user responses to notifications, including whether notifications were opened, dismissed, or acted upon.

The term “interest information” refers to inferred data representing topics, regions, or content types that are likely to be of interest to a user, derived from operation history data, browsing history data, and notification response history data.

The term “personalized recommendation information list” refers to an ordered collection of content items selected and arranged for a particular user based on interest information and other user-specific parameters.

The term “notification conditions” refers to rules or constraints specifying when and under what circumstances notifications should be generated and transmitted to a user.

The term “translation conditions” refers to rules or constraints specifying how, when, and into which languages information data should be translated for a user.

The term “information acquisition conditions” refers to rules or constraints specifying which information data should be acquired, from which sources, and at what times or in response to which events.

The term “natural-language prompt sentence” refers to an instruction or preference statement expressed in a natural language by a user and intended to be interpreted by the server or a generative AI model.

The term “structured rule information” refers to machine-readable data representing notification conditions, translation conditions, and information acquisition conditions extracted from a natural-language prompt sentence, and including at least a language type, an information type, and an execution timing.

The term “language type” refers to a designation of a natural language to be used for translation, output, or notification in the system.

The term “execution timing” refers to a temporal parameter, such as a schedule or event trigger, that specifies when a particular processing operation is to be performed by the server.

The term “event” refers to an occurrence detectable by the server, including at least the reception of new information data, the occurrence of a disaster-related update, or the satisfaction of a condition defined in structured rule information.

In one embodiment, a server executes a software program on a computing platform such as a cloud-based virtual machine including at least one central processing unit (CPU), a graphics processing unit (GPU), a main memory, and a non-transitory storage device. The server runs an operating system such as a general-purpose server operating system, a web application framework such as a server-side framework, and an HTTP server. The server communicates with a plurality of external content servers via a packet-based communication network using standard transport and application protocols.

The server uses a data acquisition module implemented with an HTTP client library to obtain information data in a first language from a plurality of information providing sources. The server receives structured data such as JavaScript Object Notation (JSON) records including fields for titles, bodies, timestamps, locations, and content identifiers. The server converts these records into internal data structures, such as relational records in a database, and normalizes the data by applying operations including character encoding unification, removal of control characters, and mapping to canonical topic identifiers. The server stores the resulting translation-target data in a non-transitory storage medium such as a relational database or a key-value data store.

The server uses a translation condition generation module to construct translation conditions for each piece of translation-target data. The server reads user attribute data, including language preferences, region preferences, and notification preferences, from a user profile table stored in the storage medium. The server computes a target language field by mapping the user's preferred language code to an internal representation, computes a target region field from the user's registered location or current network-based location, and derives an information type field by matching content tags (for example, “disaster,” “general news,” “culture”) against a predefined taxonomy table. The server constructs a prompt sentence for a generative AI model by formatting these translation conditions and the translation-target data into a single text string. For example, the server may construct a prompt sentence such as: “Translate the following Japanese disaster alert into English for foreign residents in Tokyo. Use simple language and keep technical terms accurate. Text: [Japanese disaster alert text].” The server uses a generative AI module implemented by calling an external generative AI model, such as a transformer-based large language model trained on text corpora in multiple languages. The generative AI model internally comprises multiple layers of self-attention, feed-forward sub-layers, and layer normalization components, with learned weight matrices for token embeddings, positional encodings, and attention projections. The server sends the prompt sentence as a sequence of tokens to the generative AI model via an application programming interface, with parameters such as maximum output length, temperature, and decoding strategy (for example, greedy decoding or beam search). The server receives an output token sequence that represents a translation result in the target language.

The server processes disaster-related information data using a specialized disaster translation condition module. The server identifies incoming items from disaster-related information providing sources by checking source identifiers and content tags. For each disaster-related item, the server determines a disaster type field (for example, earthquake, flood, storm) by matching keywords or structured fields in the source data against a disaster type table. The server determines an occurrence region field from geographic coordinates or textual region names contained in the source data, and maps these to normalized regional identifiers. The server computes an urgency level field by applying a rule-based classifier that evaluates fields such as magnitude, warning level, and issuance time. The server then constructs a prompt sentence that includes the disaster type, occurrence region, urgency level, and target language, along with instructions to simplify the wording. For example, the server may construct a prompt sentence such as:

“Translate and simplify the following earthquake warning into Chinese for non-expert foreign residents in Tokyo. Clearly describe what is happening and what actions should be taken. Text: [Japanese earthquake warning text].”

The server sends this prompt sentence to the generative AI model and receives a disaster translation result that is both translated and simplified. The server stores the disaster translation result in the storage medium along with metadata indicating the disaster type, occurrence region, and urgency level.

The server uses a source evaluation module to compute evaluation indices for information providing sources. The server acquires structured data representing each information providing source, including fields for domain name, historical error rate, update frequency, and topic coverage. The server also acquires evaluation criterion data defining weights and thresholds for reliability, relevance, and novelty. The server computes a reliability score by applying a weighted sum of features such as past consistency, official status, and cross-reference counts. The server computes a relevance score by comparing topic vectors derived from the source content with topic vectors derived from user interest information, using distance measures such as cosine similarity. The server computes a novelty score by comparing new content identifiers and timestamps with previously stored content to detect duplicates and stale items.

The server then constructs a prompt sentence that encodes these evaluation indices and category information for a generative AI model, for example:

“Given the following list of sources with reliability, relevance, and novelty scores, select the best sources for foreign residents in Japan and categorize them by topic. Sources: [structured list of sources and scores].”

The server sends the prompt sentence and structured source data to the generative AI model, which returns a ranked and categorized list of sources. The server writes the resulting selection and category information into an index database. The index database uses inverted indices and term-frequency structures to accelerate later retrieval, thereby reducing response time during search and question-answer operations.

The server uses an indexing and editing module to build high-quality content entries for the index database. The server retrieves raw content from the selected sources and constructs prompt sentences to instruct the generative AI model to summarize and tag the content. For example, the server may use a prompt sentence such as:

“Summarize the following government notice in easy English for foreign residents and generate three topic tags and a short description. Text: [government notice text].” The server sends the prompt sentence and content text to the generative AI model, receives summary information, tag information, and explanatory information, and stores these data items in the index database. The index database records, for each entry, a summary string, a set of tags, a link to the original source, and a language label. By storing these precomputed summaries and tags, the server reduces the computational load and latency when answering subsequent user queries.

The server provides a question-answering function by combining search over the index database with generative AI processing. The server receives, from a terminal, a question sentence in a user interface such as a chat window. The terminal transmits the question sentence, language preference, and an optional region indicator to the server. The server uses a search module to retrieve context information by querying the index database with the question sentence. The server obtains the top-ranked content entries and extracts relevant passages. The server constructs a prompt sentence that embeds the context information and the question sentence, and defines output language and expression difficulty, for example: “You are an assistant helping foreign residents in Japan. Using the following information, answer the user's question in easy English suitable for a beginner. Context: [selected passages]. Question: [user's question].”

The server sends this prompt sentence to the generative AI model, receives an answer sentence, and forwards the answer sentence to the terminal. The terminal displays the answer sentence in a message-style interface, enabling the user to scroll through the generated explanation and optionally follow links to the original sources.

The server performs personalization by analyzing user behavior logs stored in the storage medium. The server records operation history data (such as clicks and taps), browsing history data (such as content identifiers of viewed entries), and notification response history data (such as whether notifications were opened or ignored). The server uses a feature extraction module to convert these logs into feature vectors for each user, including counts of topic tags viewed, frequencies of language switches, and response delays to notifications. The server applies a recommendation algorithm, such as a matrix factorization model or a content-based similarity model, implemented using a machine learning library. The server derives interest information for each user in the form of topic weights and preferred content types. The server then selects from the translation results, disaster-related information data, and high-quality information providing sources those items with high similarity to the user's interest information. The server generates a personalized recommendation information list and transmits it to the terminal for display in a recommendation section of the user interface.

The server allows the user to define conditions for notification, translation, and information acquisition by entering a natural-language prompt sentence. The user may input, via the terminal, statements such as:
“Translate the latest Japanese news into English and notify me every morning at 8:00.”
“Provide earthquake information in Tokyo in Chinese whenever there is a new alert.”

The terminal transmits the prompt sentence to the server. The server uses a rule extraction module to parse the prompt sentence. In one embodiment, the server calls a generative AI model with a meta-level prompt, such as:
“Convert the following user instruction into a structured rule including language, content type, and schedule. Instruction: [user instruction].”

The generative AI model produces a structured representation, for example, a language type field set to English, an information type field set to news, and an execution timing field set to daily at 8:00. The server stores this structured rule information in a rule table. The server's scheduling subsystem periodically evaluates the rule table and, for each rule, executes the necessary translation processing, disaster translation processing, and notification processing only when the execution timing and trigger conditions are satisfied. By controlling translation and notification operations via structured rules derived from prompt sentences, the server reduces redundant processing, avoids unnecessary network usage, and adapts computation to user-defined conditions.

The server and terminal cooperate to provide technical improvements beyond mere automation of human tasks. The server reduces processing time and network load by normalizing translation-target data once, computing and caching translation results in the storage medium, and reusing them across multiple users with similar conditions. The server improves translation accuracy and relevance by constructing prompt sentences that specify detailed translation conditions, such as target region and information type, which are not easily handled by traditional fixed translation engines. The server reduces retrieval time by precomputing evaluation indices and building an index database with summaries and tags, which allows the search module to access relevant content in sublinear time. The server reduces error rates in disaster communication by using simplification processing controlled through explicit disaster translation conditions, thereby minimizing misinterpretation by non-expert users.

The generative AI model used by the server is trained using supervised and unsupervised learning on multilingual corpora. During training, the model receives input token sequences and target token sequences, and the server (or a training component) computes a loss function such as cross-entropy between the predicted token distribution and the true token distribution. The system updates weight parameters via gradient descent and backpropagation, using an optimization algorithm such as Adam. The model incorporates positional encodings to preserve sequence order and multi-head attention mechanisms to capture long-range dependencies. Data augmentation techniques, such as back-translation and noise injection, may be used during training to improve robustness to varied input styles. By using such a model, the server can flexibly adapt to varying prompt sentences and generate outputs that satisfy complex instructions involving translation, summarization, evaluation, and classification.

The server uses non-conventional control logic to orchestrate interactions between the generative AI model, the index database, and the rule table. Unlike conventional systems that apply fixed translation and notification rules, the server dynamically constructs prompt sentences from structured internal data and user-defined rules. Because the server encodes translation conditions, disaster translation conditions, evaluation indices, and user interest information into prompt sentences, the generative AI model processes input in a way that is specific to the computing architecture, not merely simulating human reasoning. This interaction pattern reduces round-trip calls, consolidates multiple operations (translation, simplification, explanation) into a single model invocation when possible, and thus improves computational efficiency.

In another embodiment, the server may replace or supplement the external generative AI model with an on-premise model instance running on a dedicated GPU server. In this case, the server loads the model parameters into GPU memory and performs tokenization, inference, and decoding locally. The server may also partition the model across multiple GPUs and use model parallelism to handle longer input sequences, which is beneficial when prompt sentences include large context information. This configuration allows the server to further optimize latency and throughput while maintaining control over data locality and privacy.

In yet another embodiment, the terminal may perform part of the personalization and display adaptation processing. The server transmits high-level recommendation information and structured content descriptors to the terminal, and the terminal uses local preference settings and display capabilities to filter and format content. The terminal may, for example, adapt font sizes or hide low-urgency notifications based on device type and user interface constraints. This division of processing reduces server load and balances computation between the server and the terminal.

The described architecture provides technical effects in terms of faster response times, reduced storage redundancy, and improved data management. By structuring translation-target data, evaluation indices, and rule information in a specific way, and by using prompt sentences to control a generative AI model within that structure, the server improves the functioning of the computer system itself, rather than merely automating a human workflow.

The system thus achieves technical improvements such as lowered average query latency, improved translation and recommendation accuracy, reduced network bandwidth consumption through selective notification, and reduced computational overhead through reuse of precomputed summaries and translations.

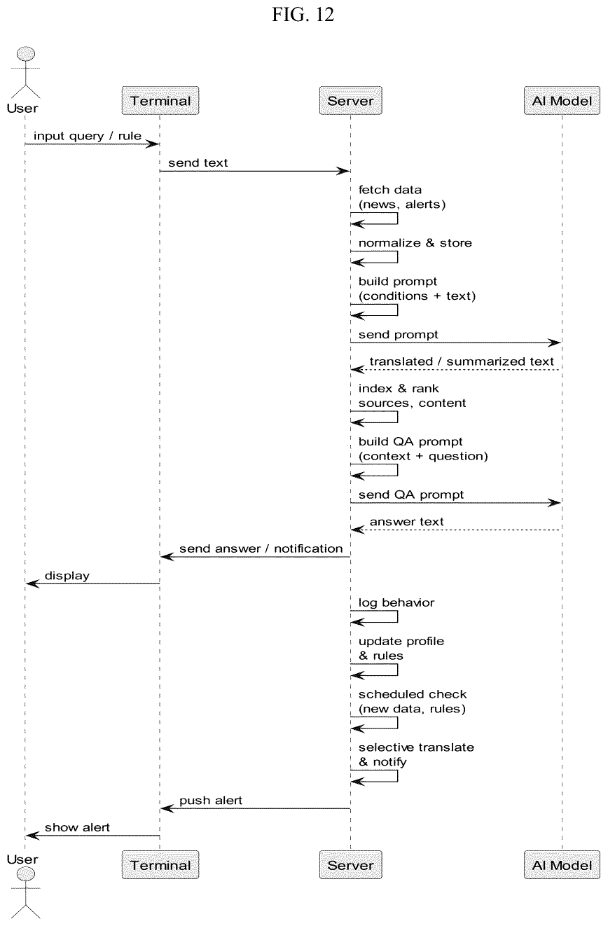

The following describes the processing flow using FIG. 12.

### Step 1:

Server acquires raw information data from external sources.

Server sends HTTP requests to multiple information providing sources over a communication network and receives structured responses such as JSON objects. The input is raw network responses containing fields like title, body, timestamp, location, and source identifier. Server parses these responses, validates status codes, and converts the data into internal records. The output is a set of normalized internal data objects in a first language, each associated with metadata such as source ID and content type.

### Step 2:

Server normalizes and stores translation-target data.

Server takes the internal data objects as input and performs data cleaning operations, including character encoding normalization, removal of control characters, and unification of date and location formats. Server maps raw topic labels to canonical categories using a lookup table stored in a database. The input is the parsed internal records; the output is translation-target data records stored in a storage medium, each tagged with a canonical information type and prepared for translation.

### Step 3:

Server retrieves user attribute data and determines translation conditions.

Server queries a user profile table using user identifiers as input. Server reads language preferences, region preferences, and notification preferences. Server computes translation conditions by combining the information type of each translation-target record with the user's preferred language and region. The input is user profile records and translation-target records; the output is a set of translation condition objects including target language, target region, and information type for each relevant content item.

### Step 4:

Server constructs prompt sentences for general translation.

Server takes translation-target data and corresponding translation condition objects as input. Server formats textual templates that embed the target language, region, information type, and the original text into a single prompt sentence. For example, server may generate: “Translate the following Japanese news article into English for foreign residents in Tokyo. Maintain accuracy and use clear, simple language. Text: [original text].”

The output is a collection of prompt sentences ready to be sent to a generative AI model, each associated with its original record ID and translation condition object.

### Step 5:

Server sends translation prompts to the generative AI model and obtains translation results. Server transmits each prompt sentence as input to a generative AI model via an API call, along with parameters such as maximum token length, decoding strategy, and output language constraints. The generative AI model executes internal neural network computations (token embedding, self-attention, feed-forward transformations) to produce translated text. Server receives the translated text sequences as output. The input is the set of prompt sentences; the output is a set of translation results in target languages, each mapped back to its original content identifier.

### Step 6:

Server processes disaster-related information with specialized conditions.

Server filters translation-target data to select disaster-related information based on source IDs and content type tags. Server computes disaster translation conditions by evaluating disaster type, occurrence region, and urgency level from the data fields (for example, magnitude or warning level). Server constructs disaster-specific prompt sentences such as:
“Translate and simplify the following earthquake warning into Chinese for non-expert foreign residents in the affected region. Clearly describe what is happening and what actions should be taken. Text: [disaster text].”

The input is raw disaster-related records; the output is a set of disaster-specific prompt sentences containing fields for disaster type, region, urgency, and original text.

### Step 7:

Server obtains disaster translation and simplification results from the generative AI model. Server sends the disaster-specific prompt sentences as input to the generative AI model with parameters tuned for concise, clear output. The generative AI model generates translated and simplified explanations. Server receives and stores the disaster translation results together with metadata such as disaster type and occurrence region. The input is the disaster prompt sentences; the output is a set of translated, simplified disaster messages suitable for immediate notification.

### Step 8:

Server computes evaluation indices for information providing sources.

Server aggregates structured data for each information providing source, including error history, update frequency, topic coverage, and cross-reference counts. The input is a set of source-level metrics and evaluation criterion data (weights and thresholds). Server applies mathematical operations, such as weighted sums and normalization, to compute reliability, relevance, and novelty scores. The output is a set of evaluation indices for each source, stored as numeric fields linked to source identifiers.

### Step 9:

Server evaluates and categorizes sources with the aid of a generative AI model.

Server constructs a prompt sentence that includes source descriptors and evaluation indices, for example:
“Given the following sources with reliability, relevance, and novelty scores, select the most suitable sources for foreign residents and group them by topic. Sources: [structured list].” The input is the structured list of sources and computed indices. Server sends this prompt sentence to the generative AI model, which returns a ranked list and category assignments. The output is a curated set of sources, each with an assigned category, stored in an index database.

### Step 10:

Server generates summaries and tags for indexed content.

Server retrieves raw content from curated sources in the index database as input. Server constructs prompt sentences that request summarization and tagging, such as:
“Summarize the following public notice in easy English for foreign residents, and provide three topic tags and a short description. Text: [content].”

Server sends these prompt sentences and content to the generative AI model, which returns summary text, tag lists, and explanatory descriptions. The output is enriched index entries containing summaries, tags, and explanatory information, stored for fast retrieval.

### Step 11:

User submits a search request or question sentence via the terminal.

User interacts with the terminal application and inputs a search phrase or a natural-language question, such as “What should I do in case of an earthquake in Tokyo?” The terminal receives this user input as text, attaches user language preference and optional region data, and transmits it to the server over the communication network. The input to the server is a structured request including the question sentence and user context; the output at the terminal is a request message sent to the server.

### Step 12:

Server retrieves context information from the index database.

Server receives the question sentence and user context as input. Server uses a search module to query the index database for content entries related to the question. Server applies full-text search and tag-based filtering to compute a relevance score for each entry. The output is a set of top-ranked entries, from which server extracts key passages and summaries, forming context information for the generative AI model.

### Step 13:

Server constructs a question-answer prompt sentence and obtains an answer.

Server combines the user's question sentence and the extracted context information into a single prompt sentence, for example:
“You are an assistant helping foreign residents in Japan. Using the following information, answer the user's question in easy English. Context: [passages]. Question: [user question].” The input is the question sentence, context information, and user preferences (language, difficulty). Server sends this prompt sentence to the generative AI model and receives an answer sentence as output. The server then post-processes the answer to remove duplicates or irrelevant content and prepares it for delivery.

### Step 14:

Server generates and sends notification data to the terminal.

Server selects translation results and disaster translation results based on user language settings, region settings, and notification settings. The input is a set of translated content items and user settings. Server packages selected content as notification payloads, including titles, short summaries, and identifiers. Server transmits these payloads to terminal devices using a push notification service. The output is notification data delivered to terminals, ready to be displayed by the operating systems.

### Step 15:

Terminal receives notifications and requests full content from the server.

Terminal's operating system receives the notification payload from the network service as input. Terminal displays a brief alert containing title and summary. When the user taps the notification, terminal extracts the content identifier from the payload and sends a content request to the server. The output is a request message asking for full translated or simplified content corresponding to the notification.

### Step 16:

Server returns full translated or simplified content to the terminal.

Server receives the content request with a content identifier as input. Server queries the storage medium for the corresponding translation result or disaster translation result. Server formats the content into a structured response including full text, metadata, and related links. The output is a response message sent to the terminal, containing the complete content to be rendered in the user interface.

### Step 17:

Server logs user behavior for personalization.

Server receives interaction events from the terminal, such as article views, question submissions, and notification openings, as input. Server writes these events as operation history data, browsing history data, and notification response history data into log tables. Server aggregates these logs to form feature vectors representing user behavior, including counts of topic tags and language usage. The output is updated user behavior profiles stored in the storage medium.

### Step 18:

Server computes user interest information and generates personalized recommendations. Server uses the behavior profiles and content tags as input to a recommendation algorithm. Server calculates similarity measures between user interest vectors and content topic vectors, and ranks content items accordingly. Server produces a personalized recommendation information list containing identifiers, titles, summaries, and tags. The output is a structured recommendation list, which server sends to the terminal to be displayed in a recommendation view.

### Step 19:

User defines rules via natural-language prompt sentences.

User opens a settings or assistant configuration screen on the terminal and types a natural-language instruction, such as “Translate the latest Japanese news into English and notify me every morning at 8:00.” Terminal captures this instruction as a textual prompt sentence and transmits it to the server, along with user identifiers. The input to the server is the natural-language prompt sentence; the output at the terminal side is a configuration request message.

### Step 20:

Server converts natural-language instructions into structured rule information.

Server receives the prompt sentence as input and uses a rule extraction module to interpret it.

Server may construct a meta-prompt for a generative AI model, such as:
“Convert the following user instruction into a structured rule including language, content type, and schedule. Instruction: [user instruction].”

Server sends this meta-prompt to the generative AI model, receives a structured representation (language type, information type, execution timing), and validates the fields. The output is structured rule information stored in a rule table associated with the user.

### Step 21:

Server executes scheduled and event-driven processing based on structured rules.

Server's scheduler reads the rule table at regular intervals and also listens for trigger events, such as arrival of new disaster-related information data. The input is the set of structured rules and current system state (time, new content flags, event indicators). Server determines which rules are active, selects relevant translation-target data, and executes translation processing or disaster translation processing only when conditions are met. Server then generates and sends notification data according to the rules. The output is a set of executed workflows resulting in timely, filtered notifications and translations sent to terminals.

### Step 22:

User views responses and optionally issues follow-up questions.

User receives answer sentences and recommended content on the terminal. The terminal renders these items in a user interface based on the responses provided by the server. After reading the content, user may type follow-up questions, which become new question sentences. Terminal sends these follow-up question sentences as input to the server, and the processing repeats from the context retrieval and prompt construction steps. The output is a continuous interactive experience where the user obtains updated, context-aware information driven by the described processing flow.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information provision systems for foreign users and disaster-prevention purposes largely rely on rigid keyword-based search and manually defined rule sets. These systems typically treat (i) collection and evaluation of information sources, (ii) natural language analysis and categorization of documents, and (iii) interpretation of user queries as separate, weakly connected processes. As a result, such systems suffer from several technical problems in terms of computer technology.

First, conventional systems are not configured to accept arbitrary natural language prompt sentences from users and to convert these prompt sentences into structured search parameters in a robust and scalable manner. Instead, they depend on fixed query forms or simple keyword extraction, which leads to low recall and precision in database retrieval, inefficient use of indexing structures, and increased load on processing resources. This causes unnecessary consumption of storage access bandwidth and processor time, for example by executing broad, poorly targeted database queries.

Second, existing systems do not effectively integrate generative AI models into the core data-processing pipeline for both upstream and downstream operations. In particular, many systems use generative AI models only to generate human-readable text, while source selection, document analysis, classification, and search remain based on traditional deterministic logic. This fragmented use of generative AI models prevents the system from using the models to (i) automatically derive evaluation criteria for information sources, (ii) adjust category and tag assignment, and (iii) interpret complex user intents. As a result, the system cannot adapt its internal data structures and retrieval strategies to evolving content and user needs, thereby limiting scalability and responsiveness.

Third, conventional information provision systems generally lack a unified mechanism to evaluate and categorize information sources themselves based on dynamically interpretable evaluation criteria. Source reliability and categorization are often hard-coded or manually curated, which is not scalable as the volume and diversity of online sources increase. This can lead to the inclusion of low-reliability sources in the searchable corpus, requiring additional validation checks at query time and increasing computational overhead.

Fourth, known systems are not optimized to generate context-sensitive responses that are simultaneously conditioned on (i) structured search results, (ii) inferred user attributes such as emotion, and (iii) specific domains such as foreigner-oriented guidance and disaster-prevention information. Without systematic integration of these factors, the system cannot efficiently select and format information in a way that minimizes redundant post-processing and repeated model calls, and cannot effectively tailor the content while maintaining efficient use of computational resources.

In summary, there is a need for a computer-implemented system that technically improves (1) the way user prompt sentences are interpreted into structured parameters suitable for efficient database querying, (2) the way large-scale, heterogeneous textual data are collected, analyzed, classified, and indexed, and (3) the way generative AI models are orchestrated to perform both upstream (source analysis, intent extraction) and downstream (answer generation, emotion-based adaptation) processing so as to reduce computational waste, improve retrieval accuracy, and enhance overall system performance as an information processing apparatus.

The specific processing by the specific processing unit 290 of the data processing device 12 in Example 2 is realized by the following means.

The present invention provides a server comprising a processor and a memory storing instructions that, when executed by the processor, cause the processor to receive a prompt sentence from a terminal and, using a generative AI model controlled by a prompt sentence that instructs the generative AI model to perform semantic analysis and conversion into structured search parameters, analyze the user intention, location, category, and constraint conditions contained in the prompt sentence and determine a search category, a search target region, and search conditions; to acquire electronic document data from information sources via a communication network by crawling the information sources based on predefined evaluation criteria and keywords; to perform natural language processing on the acquired electronic document data, including language identification, syntactic analysis, keyword extraction, sentiment estimation, and named entity extraction, to generate analysis data representing content and evaluation of the electronic document data; to classify the electronic document data based on the analysis data using upper-level concepts including living information, tourist information, restaurant information, and disaster-prevention information, and to attach tags including at least one of place, price range, congestion level, and family suitability; to store the classified and tagged electronic document data in a data management structure on an information storage device in association with search index information so that the electronic document data are searchable by category, place, tag, and language; to search the stored electronic document data based on the determined search category, search target region, and search conditions, and extract candidate information including foreigner-oriented information and disaster-prevention information; to cause the generative AI model, using a prompt sentence that instructs the generative AI model to summarize the candidate information and to generate natural-language explanations and recommendations, to generate processed information, and to transmit the processed information to the terminal; and to cause the generative AI model, using a prompt sentence that instructs the generative AI model to analyze evaluation criteria of the information sources, to analyze the information sources and determine reliability and category of the information sources based on an analysis result. This enables technical improvements in computer operation by reducing unnecessary database queries and post-processing, optimizing use of indexing and storage structures through AI-generated structured parameters, dynamically filtering and categorizing information sources for higher-quality corpora, and orchestrating generative AI processing so that intent interpretation, source evaluation, document classification, and response generation are integrated into a single, efficient pipeline, thereby improving throughput, latency, and accuracy of information retrieval and presentation in a computer-implemented information provision system.

The term “processor” refers to a hardware computation unit, or a combination of such units, that executes machine-readable instructions, and includes, for example, a central processing unit, a graphics processing unit, a digital signal processor, or any integrated circuit capable of performing arithmetic and logic operations.

The term “memory” refers to a hardware storage medium configured to store instructions and data for access by a processor, and includes, for example, semiconductor memory, magnetic storage, optical storage, or any non-transitory computer-readable medium.

The term “terminal” refers to an information processing device operated by a user and configured to transmit and receive data to and from a server via a communication network, and includes, for example, a mobile terminal, a portable information device, a desktop computing device, or a web browser client.

The term “prompt sentence” refers to a natural language expression or text sequence input by a user or generated by a system that is provided as input to a generative AI model to specify a task, convey an intent, or constrain a generated output.

The term “generative AI model” refers to a trained computational model that generates text or other data based on input sequences, and includes, for example, a large-scale neural network configured for language generation, text completion, or content transformation.

The term “semantic analysis” refers to a process of interpreting the meaning of a prompt sentence or document, including determining user intent, identifying relevant concepts, and extracting relationships among elements in the text.

The term “structured search parameters” refers to machine-processable data elements derived from a prompt sentence, including at least one of a category, a location, a language identifier, and constraint conditions, which are formatted for direct use in database queries or information retrieval operations.

The term “user intention” refers to an objective, request, or purpose that a user seeks to achieve by inputting a prompt sentence, as inferred from linguistic cues, context, and associated constraints contained in the prompt sentence.

The term “location” refers to a geographic or spatial designation associated with a piece of information or a user request, and includes, for example, a city, region, country, area, or any other identifiable place.

The term “category” refers to a conceptual classification label that represents a type or domain of information, and is used to group electronic document data into higher-level classes for organization and retrieval.

The term “constraint conditions” refers to limiting or qualifying requirements extracted from a prompt sentence, including, for example, budget, time, congestion level, accessibility, or user preferences, that narrow or refine a search space.

The term “communication network” refers to an infrastructure that enables data transmission between devices, and includes, for example, the Internet, a local area network, a wireless network, or any combination thereof.

The term “information source” refers to a provider or repository of electronic document data accessible via a communication network, and includes, for example, a website, a data feed, a content server, or an online service.

The term “electronic document data” refers to digital content including text, metadata, and associated information obtained from an information source, and may include articles, reviews, descriptions, or structured records represented in electronic form.

The term “evaluation criterion” refers to a rule, metric, or condition used to assess an information source or electronic document data, including, for example, reliability, relevance, recency, or topical coverage.

The term “crawling” refers to an automated process in which a program accesses multiple locations of an information source via a communication network according to predefined rules to retrieve electronic document data.

The term “natural language processing” refers to a set of computational techniques that analyze, interpret, or manipulate human language text, including, for example, tokenization, parsing, tagging, and semantic interpretation.

The term “language identification” refers to a process that determines a natural language associated with a given text, such as identifying whether the text is in a first language, a second language, or another language.

The term “syntactic analysis” refers to a process of analyzing grammatical structure in text, including identifying parts of speech, phrases, and dependency relations among words.

The term “keyword extraction” refers to a process that selects one or more terms or phrases from text that are deemed representative or significant for describing the content of the text.

The term “sentiment estimation” refers to a process that determines an affective polarity or emotional tone of text, including, for example, classifying the text as positive, negative, or neutral, or assigning a sentiment score.

The term “named entity extraction” refers to a process that identifies and labels particular items in text such as place names, facility names, business names, person names, or other specific entities.

The term “analysis data” refers to structured information generated by applying natural language processing to electronic document data, including extracted features such as language, keywords, sentiment, entities, and other derived attributes.

The term “upper-level concepts” refers to more abstract classification notions used to organize electronic document data into broad informational domains, such as categories that encompass multiple specific subtopics.

The term “living information” refers to information related to daily life activities, including housing, shopping, public services, or other matters relevant to everyday living.

The term “tourist information” refers to information that supports travel or sightseeing, including attractions, routes, activities, or other content intended for visitors.

The term “restaurant information” refers to information regarding eating and drinking establishments, including menus, prices, locations, user evaluations, and operating hours.

The term “disaster-prevention information” refers to information concerning preparation for, response to, or recovery from hazards, including warnings, evacuation guidance, and safety measures.

The term “tag” refers to a descriptive label associated with electronic document data that indicates an attribute such as place, price range, congestion level, or suitability for certain user groups, and is used to refine or filter search results.

The term “price range” refers to a classification of cost level associated with an item or service, expressed as a range or category indicating relative expense.

The term “congestion level” refers to an attribute indicating an expected or observed degree of crowding or occupancy at a place or event.

The term “family suitability” refers to an attribute indicating whether a place, service, or content is appropriate or convenient for users accompanied by family members, including children.

The term “data management structure” refers to an organization scheme used in a storage device to arrange and index electronic document data, including, for example, tables, indexes, and relationships in a database.

The term “information storage device” refers to hardware that stores electronic data persistently, including, for example, a magnetic disk, a solid-state drive, or a storage array.

The term “index information” refers to auxiliary data associated with electronic document data that support efficient search operations, including identifiers for categories, places, tags, languages, or other searchable attributes.

The term “search category” refers to a category value used as a parameter in a retrieval operation to restrict or guide selection of stored electronic document data.

The term “search target region” refers to a location-based parameter that specifies an area within which relevant electronic document data are to be retrieved.

The term “search conditions” refers to a set of parameters, including categories, locations, tags, and constraint conditions, used to define criteria for selecting electronic document data from storage.

The term “candidate information” refers to one or more items of electronic document data retrieved from storage as potential responses to a user request based on search parameters.

The term “foreigner-oriented information” refers to electronic document data that has been selected or adapted to assist users who are not native to a particular region or language, including explanations, guidance, and recommendations tailored to such users.

The term “processed information” refers to information that has been transformed from candidate information into a user-facing form, such as summarized or reformatted text generated by a generative AI model.

The term “explanation and recommendation information” refers to natural-language content that describes, clarifies, or suggests options to a user, including reasons, comparisons, and guidance derived from candidate information.

The term “reliability” refers to an assessment value or level indicating trustworthiness or quality of an information source or electronic document data, based on evaluation criteria such as origin, consistency, or reputation.

The term “question content” refers to the semantic content of a user's question, including requested topics, entities, and conditions expressed in a prompt sentence.

The term “structured answer candidates” refers to answer elements generated in a machine-processable form, such as lists, key-value pairs, or templates, which can be combined or refined to form a final user-oriented answer.

The term “supplementary explanations” refers to additional descriptive text that provides context, background, or details beyond a direct answer to a user's question.

The term “user-oriented answer information” refers to a final response presented to a user, produced by integrating structured answer candidates with search results from stored electronic document data and formatting the integrated content in natural language.

The term “user emotion” refers to an inferred emotional state of a user, derived from analysis of prompt sentences, input history, or other interaction data, and may include states such as anxiety, curiosity, satisfaction, or urgency.

The term “input history” refers to a sequence of past interactions or prompt sentences provided by a user over time, which can be used to infer preferences, context, or emotional trends.

The term “emotional state of the user” refers to a current or predominant affective condition of a user as determined by analyzing user emotion, and is used to adapt selection and presentation of information.

The term “emotion-adapted presentation” refers to a manner of providing information in which content selection, wording, or emphasis is modified according to a user's emotional state to improve understanding, comfort, or responsiveness.

In one embodiment, a server, a terminal, and a user cooperate to implement the invention. The server executes a program stored in a memory by using a processor, and the terminal operates as a user interface device. The user operates the terminal to input a prompt sentence and receive processed information. The server is physically implemented by a computer system that includes at least one central processing unit (CPU), such as a general-purpose processor, at least one graphics processing unit (GPU) configured for parallel numerical computation, such as a general-purpose GPU card, a main memory, a non-volatile storage device such as a solid-state drive (SSD), and a network interface controller connected to a communication network such as the Internet. The server executes an operating system, such as a UNIX-like operating system, and application software implemented, for example, in a high-level programming environment such as a Python runtime. The server further executes server-side middleware, such as a web application framework, a database management system such as a relational database server, and a set of libraries for web crawling, text parsing, and machine learning.

The terminal is implemented by a portable information processing device, such as a smartphone or a tablet, and the terminal includes a touch-sensitive display, a wireless communication interface, a processor, and a memory. The terminal executes a mobile operating system, such as a handheld device operating system, and a dedicated application or web browser that provides an input field for a prompt sentence and displays a response from the server. The user holds the terminal in hand, views the display, and inputs a prompt sentence by using a software keyboard or voice input, for example in English or another supported language. The user may input a prompt sentence such as “Please tell me some recommended sightseeing spots in Tokyo that are easy for foreign visitors and suitable for a one-day trip.” or “I want to find cheap ramen restaurants in Osaka that are popular among locals and easy to access by subway.”

The server uses a generative AI model as a core computational component to convert prompt sentences and source data into structured parameters and user-oriented responses. In one embodiment, the generative AI model is implemented as a transformer-based neural network that includes a plurality of layers of self-attention blocks and feed-forward blocks. The server stores the parameters of the generative AI model in the storage device and loads the parameters into GPU memory at runtime. The server represents each token of a prompt sentence by a vector embedding, and the server applies multi-head self-attention operations across tokens to compute contextualized embeddings. The server processes the embeddings through a plurality of transformer layers, and the output of the final layer is used to predict a sequence of output tokens or a structured representation of the prompt sentence.

The server trains or fine-tunes the generative AI model in advance by using training data that pairs user-like prompt sentences with corresponding structured search parameters or answer texts. The server defines a loss function such as a cross-entropy loss between predicted token sequences and reference token sequences, and the server updates parameters of the generative AI model by using a gradient-based optimization algorithm such as stochastic gradient descent or an adaptive optimization algorithm. During training, the server applies techniques such as mini-batch training, dropout regularization, and learning-rate scheduling to stabilize convergence. The server may perform data augmentation by paraphrasing prompt sentences or by adding noise to training examples to improve robustness to diverse user input.

The server stores electronic document data obtained from information sources, such as public websites or content feeds, in a relational database. The server uses a schema that includes a document table, a category table, a tag table, and association tables. The server assigns a unique identifier to each document and stores in each row of the document table fields such as a URL, a title, a main text, a language code, a category identifier, a sentiment score, and a reliability score. The server stores in a tag table tag identifiers and tag names such as “Tokyo,” “ramen,” “family-friendly,” “budget,” or “evacuation.” The server stores in association tables pairs of document identifiers and tag identifiers to realize many-to-many relationships. The server defines indexes on fields such as category identifiers, tag identifiers, language codes, and location-related tags to accelerate retrieval.

The server executes a web crawler implemented in a scripting environment using a crawling framework to acquire electronic document data. The server configures the web crawler with seed URLs, evaluation criteria, and keyword patterns for topics such as living information, tourist information, restaurant information, and disaster-prevention information. The server sends HTTP requests to these information sources and receives HTML responses. The server parses HTML documents by using an HTML parsing library and extracts content sections such as main articles, user reviews, or announcement texts. The server normalizes character encoding to a unified format and removes markup elements that are not relevant to content, such as scripts or style definitions. The server stores the cleaned text, together with metadata such as timestamps and source URLs, into the document table or a staging area in the database.

The server performs natural language processing on each stored document by using a combination of rule-based modules and learned models. The server applies language identification to each document using a probabilistic classifier that considers character n-gram frequencies and word-level statistics. The server performs tokenization and syntactic analysis by using a dependency parser, which outputs part-of-speech tags and syntactic dependency relations. The server computes document-level and sentence-level embeddings by using a pre-trained transformer encoder, and the server uses these embeddings as feature vectors for downstream tasks.

The server extracts keywords from each document by computing term frequency-inverse document frequency (TF-IDF) scores across the corpus and by selecting tokens and phrases whose TF-IDF scores exceed a threshold. The server additionally uses attention weights from transformer layers as indicators of token importance to refine keyword selection. The server estimates sentiment by applying a classification layer on top of a sequence embedding; the classification layer outputs a probability distribution over sentiment classes such as positive, neutral, and negative. The server uses a cross-entropy loss during training of this sentiment classifier, and the server updates its weights based on labeled examples of reviews or comments. The server detects named entities, such as locations, facilities, transportation hubs, and organization names, by using a sequence labeling model based on a transformer encoder and a conditional random field output layer, which assigns entity labels to each token.

The server uses the analysis results to classify each document into upper-level concepts. In one embodiment, the server uses a multi-label classifier that receives as input a feature vector consisting of document embeddings, sentiment scores, and a bag-of-tags representation and outputs probabilities for categories such as living information, tourist information, restaurant information, and disaster-prevention information. The server thresholds these probabilities to assign one or more categories to each document. The server then derives and attaches tags by applying a tag-generation engine that uses a combination of rule-based mappings from detected entities (for example, mapping a city name entity to a location tag) and clustering of embedding vectors to discover additional tags that correspond to common themes. The server updates the database records with the assigned categories and tags and refreshes indexes to reflect the new assignments.

The server receives a prompt sentence and interprets it into structured search parameters in a way that improves computer performance. The server passes the prompt sentence to the generative AI model together with a control prompt sentence that defines an output format, such as “Convert the following user request into a category, a location, a language, and constraint conditions.” The user may input a prompt sentence such as “I want to find child-friendly sightseeing places in Kyoto that are not too crowded and have easy public transportation access.” The server tokenizes the prompt sentence and runs it through the generative AI model. The model outputs a token sequence that encodes a structured representation such as a category “tourist information,” a location “Kyoto,” a language “English,” and constraint conditions such as “child-friendly,” “not crowded,” and “easy public transportation access.”

The server parses this output and maps the extracted values to internal identifiers in the database schema. The server maps the category string to a category identifier, the location to a location tag identifier, and each constraint condition to one or more tag identifiers or numeric filters. Because the generative AI model compresses the user's multi-sentence or ambiguous expression into a concise set of discrete parameters, the server avoids issuing overly broad queries that would otherwise scan large portions of the database. The server instead constructs narrowly scoped SQL queries that leverage indexes on category and tag columns, greatly reducing the number of rows read from disk and the memory required to process intermediate result sets. This contributes to significantly reduced response time and lower CPU utilization in comparison to systems that only perform keyword matching. The server uses the generative AI model not only for outward-facing answer generation but also for internal data structure optimization. The server applies a similar control prompt sentence to analyze evaluation criteria of information sources. For instance, the server may provide a prompt sentence such as “Analyze the following description of an information source and determine its reliability level and topic category.” and append text that describes the source's update frequency, editorial policy, and historical accuracy. The generative AI model produces a discrete reliability score and topic labels that the server stores as metadata for the information source. The server then uses this reliability score as a feature in ranking documents at query time, so that low-reliability sources are deprioritized. This reduces the probability that noisy or unreliable documents are returned, thereby improving precision of search results and reducing the amount of post-filtering computation required after retrieval.

The server generates a final response by applying the generative AI model to candidate information selected from the database. The server passes to the generative AI model a control prompt sentence that specifies a desired style and content constraints, such as “Using the following list of places, generate a friendly explanation and recommendations for a foreign visitor.” and appends summaries of selected documents. The generative AI model uses its transformer layers to attend across multiple place descriptions and generate coherent text that avoids redundant information and respects time or budget constraints that were expressed in the original prompt sentence. The server limits the length of the generated text and compresses multiple documents into a single, structured recommendation, thereby reducing the amount of data that must be transmitted to the terminal and rendered on the display. This improves communication efficiency and reduces power consumption at the terminal.

The server can optionally incorporate user emotion analysis to further refine selection and presentation of information. The user may input a prompt sentence that includes emotional content, such as “I am very nervous about earthquakes, please explain what I should do in Tokyo.” The server sends the prompt sentence and a limited history of past interactions to the generative AI model with a control prompt sentence such as “Analyze the user's emotional state from the following messages.” The generative AI model outputs an emotion label such as “anxiety” or “urgency.” The server maps this label to a set of specialized disaster-prevention documents tagged as beginner-friendly or reassurance-focused and selects those documents for inclusion in the candidate information. The server also instructs the generative AI model to use calmer wording and more detailed instructions. In this way, the server controls both data selection and presentation style based on machine-computed emotion, which differs from simple keyword-based filtering and results in fewer follow-up queries and reduced processing cycles.

The server implements a modular architecture in which a prompt interpretation module, a source evaluation module, a natural language analysis module, a classification and tagging module, and a response generation module share common data structures but operate as distinct software components. Each module uses standardized internal representations, such as document embeddings and parameter dictionaries, so that the server can replace or upgrade individual modules without redesigning the entire system. For instance, the server can swap a first generative AI model for a second generative AI model with a different number of layers or attention heads, while preserving the same structured output format. This modularity allows incremental improvement of performance and accuracy.

The server applies several non-conventional processing techniques that go beyond simple automation of human tasks. For example, the server maintains a cache of frequently occurring structured search parameter combinations that are derived from prompt sentences. When the server detects that a new prompt sentence yields the same structured parameters as a previously processed prompt sentence, the server reuses a pre-computed query plan and ranked candidate set. This reuse is enabled by the deterministic mapping from generative-model output to internal identifiers, and it reduces the amount of computation for SQL planning, execution, and subsequent model calls for answer generation. The server further records statistics on the execution time and cache hit rate to automatically adjust thresholds for caching and reuse, thereby optimizing system throughput.

The server additionally uses features known only to machine processing, such as internal vector distances between document embeddings and prompt embeddings, to refine scores for candidate information. The server computes a similarity score by taking the cosine similarity between an embedding derived from the structured parameters and embeddings of candidate documents. The server linearly combines this similarity score with reliability scores and sentiment scores to compute a final ranking score. This multi-dimensional scoring cannot practically be performed in a purely manual workflow and yields higher-quality, context-aware rankings. Because the scoring is performed on pre-computed embeddings and numeric attributes, the server reduces the need for repeated full-model inference on each document at query time, which improves computational efficiency.

The terminal uses the processed information received from the server to control output to a display and to adjust its graphical user interface. The terminal parses the response, which includes both a generated text and a structured list of items. The terminal displays the text in a scrollable area and renders items as selectable elements. When the user selects an item, the terminal may open a map application or initiate a call, thereby bridging the digital information with real-world actions such as navigation to a tourist spot or contacting a restaurant. In disaster-prevention scenarios, the terminal may use information from the server, such as evacuation routes and shelter locations, to display location markers on a geographic map and to issue local notifications or alarms.

The described embodiment improves computer technology by changing how the server organizes and accesses data and how the server orchestrates use of the generative AI model. By converting natural language prompt sentences into compact structured search parameters before issuing database queries, the server reduces the number of documents that must be scanned, the number of joins that must be performed, and the amount of data that must be transferred from storage to memory. By pre-processing documents into categorized and tagged structures and by storing vector embeddings, the server shifts computationally expensive language understanding from query time to offline processing, thereby lowering latency for end users. By integrating generative AI outputs into indexing and source evaluation, the server improves precision and recall of search results and reduces the need for human-curated rules. These technical changes result in faster response times, reduced CPU and I/O load, improved accuracy of retrieved information, and more efficient use of network bandwidth between the server and the terminal.

In alternative embodiments, the server may employ different neural network architectures for the generative AI model, such as encoder-decoder transformers or recurrent neural networks with attention. The server may store documents in other types of databases, such as a document store or a graph database, and may adapt the structured search parameters accordingly. The server may deploy multiple generative AI models specialized for different domains, such as a first model for tourist information and a second model for disaster-prevention information, and may route prompt sentences to an appropriate model based on initial classification. The server may also execute on a distributed cluster of machines, with different modules running on separate nodes, while preserving the same logical processing flow and data structures described above.

In all of these embodiments, the server uses concrete hardware resources, defined data structures, and specific algorithmic steps to achieve improvements in processing speed, retrieval accuracy, and resource utilization, and the system, as a whole, implements more than an abstract idea by technically modifying how computers store, search, and generate information in response to prompt sentences.

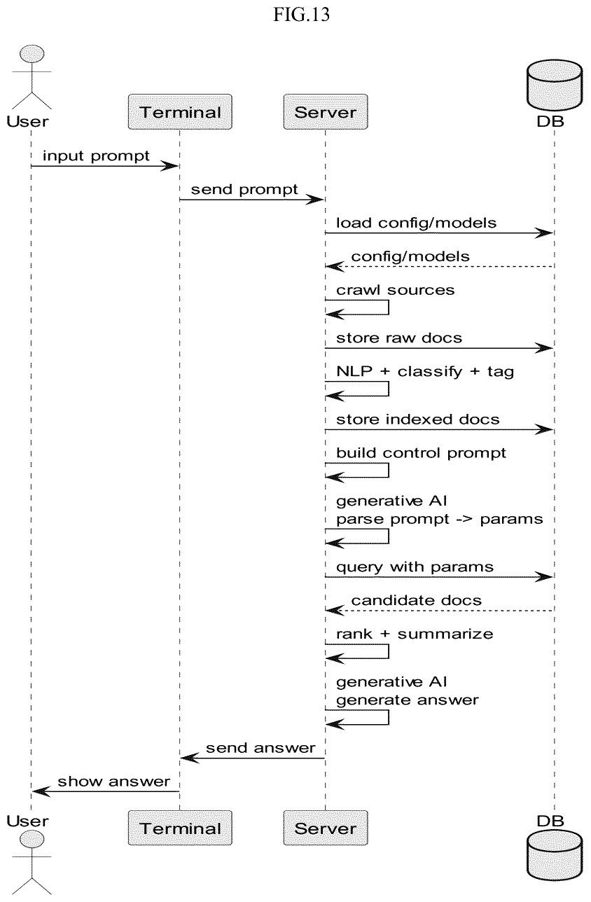

The following describes the processing flow using FIG. 13.

### Step 1:

The server initializes system resources. The server loads configuration data from a storage device, including a list of seed URLs, evaluation criteria for information sources, category definitions, and tag definitions. The server loads model parameters for a generative AI model and other natural language processing models into main memory and, if available, into GPU memory.
Input: configuration files, model parameter files, database connection parameters.
Output: in-memory configuration objects, initialized model instances, and active database connections.

The server parses the configuration files, allocates memory for model weights, opens connections to a database management system, and prepares internal data structures such as caches and queues.

### Step 2:

The server collects raw electronic document data from information sources. The server executes a web crawler that uses HTTP requests to access URLs specified in the configuration. The server retrieves HTML pages and related resources from remote hosts over a communication network.
Input: seed URL list, evaluation criteria, keyword patterns.
Output: raw HTML documents and associated metadata (URL, response code, fetch time).

The server iterates over the URL list, applies the evaluation criteria and keyword patterns to decide which links to follow, and stores the HTML responses in a temporary storage area or a staging table in the database.

### Step 3:

The server extracts textual content from the collected HTML documents. The server parses each HTML document by using an HTML parsing library and removes non-content elements such as scripts, styles, and navigation menus.
Input: raw HTML documents and metadata.
Output: cleaned text bodies, titles, and updated metadata records.

The server processes the HTML tree structure, selects main content nodes based on tag heuristics (for example, article, main, p, h1-h3), concatenates text nodes, normalizes character encodings to a unified format, and writes the cleaned text and titles back to the database.

### Step 4:

The server performs basic natural language processing on the cleaned text. The server detects the language of each document, tokenizes the text into sentences and words, and performs part-of-speech tagging and syntactic parsing.
Input: cleaned text, titles, and metadata.
Output: language codes, token sequences, sentence boundaries, and syntactic dependency structures.

The server passes each text through a language identification module, assigns a language code such as “en” or “ja,” invokes a tokenizer and parser, and stores token lists and syntactic annotations in auxiliary tables or serialized fields associated with each document.

### Step 5:

The server computes semantic features and sentiment information. The server generates document embeddings using a transformer-based encoder and estimates sentiment using a classification head.
Input: tokenized documents and language codes.
Output: document embedding vectors, sentence embedding vectors, and sentiment scores.

The server feeds sequences of tokens into the encoder, obtains contextual embeddings from the final transformer layer, applies pooling operations (for example, mean pooling or [CLS] token extraction) to derive fixed-size vectors, and runs a classification layer to produce sentiment probabilities. The server writes these vectors and scores into the database or a feature store.

### Step 6:

The server extracts keywords and named entities. The server uses frequency-based metrics and attention weights to select representative terms and uses a sequence labeling model to detect entities.
Input: token sequences, syntactic structures, document embeddings.
Output: keyword lists and entity lists for each document.

The server calculates term frequency-inverse document frequency values, filters terms using thresholds and part-of-speech constraints, and identifies high-scoring keywords. The server runs a named entity recognition model on token sequences, labels entities such as locations, facilities, and organizations, and stores the extracted keywords and entities as structured records.

### Step 7:

The server classifies documents into upper-level categories. The server applies a multi-label classifier that uses document embeddings, sentiment scores, keywords, and entities as input features to assign category probabilities.
Input: document embeddings, sentiment scores, keyword lists, entity lists.
Output: category labels and category confidence scores for each document.

The server concatenates or otherwise combines the features into a single feature vector, feeds the vector into a classification network, obtains probabilities for categories such as living information, tourist information, restaurant information, and disaster-prevention information, thresholds the probabilities, and updates database fields to record assigned categories.

### Step 8:

The server generates and assigns tags to documents. The server maps detected entities and keywords to predefined tags and optionally derives additional tags by clustering embeddings.
Input: entity lists, keyword lists, category labels, document embeddings.
Output: tag identifiers associated with each document.

The server applies rule-based mappings (for example, mapping a city entity to a location tag and a price expression to a price-range tag), performs clustering on embeddings to find common semantic themes, labels clusters with general tags, and writes document-tag associations into tag relation tables.

### Step 9:

The server stores and indexes processed documents for efficient retrieval. The server inserts or updates rows in document tables, tag tables, and category tables, and builds or refreshes indexes.
Input: cleaned text, metadata, category labels, tags, embeddings, and sentiment scores.
Output: a structured, indexed document corpus ready for query processing.

The server writes all attributes into relational tables, ensures referential integrity between documents and tags, creates or updates indexes on category, tag, location, and language columns, and performs database maintenance operations as needed.

### Step 10:

The user operates the terminal to input a prompt sentence. The user views an input field on the terminal display and types a natural language request or question, or uses voice input that is converted to text by the terminal.
Input: user's natural language query, for example “Please tell me some recommended sightseeing spots in Tokyo that are easy for foreign visitors and suitable for a one-day trip.”
Output: a prompt sentence stored in the terminal's memory.

The user confirms the input by pressing a send or search button, and the terminal prepares the text to be transmitted.

### Step 11:

The terminal sends the prompt sentence to the server. The terminal constructs a request message containing the prompt sentence and optional user settings such as preferred language.
Input: prompt sentence and user settings.
Output: a network request transmitted to the server via a communication network.

The terminal encapsulates the prompt sentence in a structured message format, sends it over a secure protocol to a server endpoint, and waits for a response from the server.

### Step 12:

The server receives and pre-processes the prompt sentence. The server parses the incoming request, extracts the prompt sentence, and performs basic normalization.
Input: network request containing the prompt sentence.
Output: a normalized prompt sentence ready for generative model processing.

The server strips control characters, normalizes whitespace, detects the input language if necessary, and logs the request metadata for monitoring.

### Step 13:

The server interprets the prompt sentence using a generative AI model. The server constructs a control prompt sentence that instructs the model to output structured search parameters and concatenates this control prompt with the user's prompt sentence.
Input: normalized prompt sentence and control prompt sentence.
Output: structured search parameters including category, location, language, and constraint conditions.

The server tokenizes the combined text, runs it through the generative AI model, decodes the output token sequence into text, and parses the text to extract discrete parameter values. The server validates the parameters and maps textual values to internal identifiers such as category IDs and tag IDs.

### Step 14:

The server constructs and executes a database query based on the structured parameters. The server generates an SQL statement that filters documents using category, location, language, and tags corresponding to constraint conditions.
Input: category identifier, location tags, language code, constraint tags, and reliability thresholds.
Output: a set of candidate documents retrieved from the database.

The server fills an SQL template with the identifiers, includes conditions on reliability and sentiment scores, executes the query against indexed tables, and obtains a result set limited to a predefined maximum number of documents.

### Step 15:

The server ranks and refines the candidate documents. The server computes additional scores based on embedding similarity between the prompt and document embeddings and combines these scores with reliability and sentiment scores.
Input: candidate documents, document embeddings, structured parameters, and prompt embedding.
Output: an ordered list of candidate documents ranked by relevance.

The server encodes the prompt sentence into an embedding using the same encoder as used for documents, computes similarity measures such as cosine similarity between the prompt embedding and each document embedding, calculates a composite score by weighting similarity, reliability, and sentiment, sorts the candidate list by the composite score, and selects top-ranked documents for response generation.

### Step 16:

The server generates a natural language answer using the generative AI model. The server prepares a control prompt sentence that requests a user-friendly explanation and recommendations and appends summaries of the top-ranked documents.
Input: ranked candidate documents, control prompt sentence, and original prompt sentence.
Output: a generated answer text tailored to the user's request.

The server constructs a context that includes key attributes such as titles, locations, brief descriptions, and categories of the selected documents, feeds this context and the control prompt into the generative AI model, decodes the output token sequence into text, and trims or formats the text according to length constraints.

### Step 17:

The server composes a response object and sends it to the terminal. The server packages the generated answer text together with structured data about the selected documents, such as names, addresses, and tags.
Input: generated answer text and selected document metadata.
Output: a response message transmitted to the terminal.

The server serializes the data into a response format, sends the response over the communication network to the terminal, and records response timing information for performance analysis.

### Step 18:

The terminal receives and displays the response to the user. The terminal parses the response message, extracts the generated answer text and the list of recommended items, and renders them on the display.
Input: response message from the server.
Output: visual presentation of the answer and recommended items on the terminal screen.

The terminal displays the answer text in a readable layout, shows each item as a selectable element with basic information, and allows the user to tap an item to view more details or to open an external application such as a map or a dialer.

### Step 19:

The user reviews the presented information and may perform follow-up actions. The user reads the generated answer, inspects the recommended items, and optionally initiates navigation, calling, or a new query.
Input: visual output on the terminal display.
Output: user decisions, such as selecting an item or entering a new prompt sentence.

The user may decide to refine the search by inputting another prompt sentence, for example “Show only places that are free and good for children,” which restarts the interaction cycle and leads to repeated execution of the preceding steps with new parameters.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information-provision systems that use natural language processing and machine learning generally treat a generative AI model as a black box that receives raw text input and returns text output. Such systems suffer from several technical problems when deployed as interactive, multi-modal services for foreign users.

First, conventional systems lack fine-grained control over the internal behavior of the generative AI model. In typical architectures, an application simply forwards user text to the model and accepts the response. As a result, it is difficult to reliably control routing logic, to integrate structured data retrieved from heterogeneous data stores, and to enforce consistency between generated content and factual reference data. This causes increased latency due to ad-hoc post-processing, duplicated data access, and repeated calls to external services, and generally lowers throughput and determinism of the overall computing system.

Second, conventional systems are not designed to treat “prompt sentences” themselves as structured control artefacts. Prompts are often hard-coded strings scattered in application code, without systematic composition from machine-readable context such as user location, device settings, question category, database results, and speech-recognition output. This makes it technically difficult to optimize prompts based on runtime signals or feedback, and makes it impractical to adapt the system automatically to different tasks, languages, and domains. As a consequence, CPU and memory resources are wasted on repeated, suboptimal inference runs, and the quality and stability of generated outputs vary widely.

Third, conventional systems do not integrate emotion analysis into the core control loop of the generative AI model. Emotion-recognition components, when present, are generally implemented as side channels that only affect superficial user-interface elements. They do not adjust model-control parameters, routing conditions, or the structure of prompt sentences. This leads to a mismatch between the user's cognitive and emotional state and the generated responses, causing excessive back-and-forth interactions, redundant computation, and suboptimal use of network and processing resources.

Fourth, existing architectures typically do not maintain an interaction-history-driven optimization loop at the system level. While some systems log usage statistics, they do not systematically use aggregated interaction histories and user evaluation data to update prompt templates, routing thresholds, or model configuration parameters. Without such a feedback loop, the system cannot converge to more efficient prompt patterns or routing schemes over time, resulting in persistently high processing cost, increased latency, and unstable response quality.

Accordingly, there is a need for a computer-implemented system that (i) programmatically constructs and updates prompt sentences as first-class control structures, (ii) orchestrates generative AI inference together with upstream and downstream processing, (iii) integrates multi-modal emotion analysis into the generation pipeline, and (iv) uses interaction history and evaluation data to adapt model-control parameters. Such a system should improve processing efficiency, reduce latency variance, and enhance robustness and predictability of AI-generated outputs, thereby achieving a concrete improvement in the functioning of the underlying computing infrastructure.

The specific processing by the specific processing unit 290 of the data processing device 12 in Application Example 2 is realized by the following means.

The present invention provides a server comprising a processor configured to generate, from context information including at least one of audio information, text information, location information, and device setting information acquired from a user via a terminal, structured prompt sentences for a generative AI model that explicitly instruct the generative AI model to perform natural language processing, route selection, and data retrieval; to generate additional prompt sentences that instruct the generative AI model to produce explanatory or recommendation information based on reference data including information items corresponding to a target domain; to acquire emotion-related information including at least one of facial expression information and voice characteristic information, to classify an emotion state of the user by executing image processing and machine learning processing on the emotion-related information, and to append emotion conditions specifying at least one of tone, detail level, and information type to the prompt sentences as instructions for adjusting an output format and an output content of the generative AI model; to transmit the prompt sentences to the generative AI model as input data, to acquire response data output by the generative AI model, and to perform post-processing including at least one of language checking, factual consistency checking, translation processing, summarization processing, and restructuring processing on the response data; to generate presentation information including at least one of text information, audio information, and image information based on the response data and the emotion state, and to transmit the presentation information to a portable information terminal used by the user; and to store interaction history information and user evaluation information in a storage apparatus and update, based on the interaction history information and the user evaluation information, at least one of configuration elements of the prompt sentences, routing conditions, and model control parameters used for the generative AI model. This enables the computing system to treat prompt sentences as dynamically optimized control structures that orchestrate multi-stage natural language processing, data retrieval, generative inference, emotion-adaptive formatting, and post-processing, thereby reducing redundant computation, lowering end-to-end latency, improving factual consistency and stability of generated outputs, and enhancing overall efficiency and robustness of the server-side AI processing pipeline.

The term “processor” refers to a hardware execution resource, such as a central processing unit or an integrated processing circuit, configured to execute instructions and perform arithmetic, logical, control, and input/output operations required to implement the functions described herein.

The term “terminal” refers to an information processing device operated by a user, such as a portable computing device or a wearable device, that is configured to acquire information from the user and present information to the user, and to communicate with a server over a communication network.

The term “portable information terminal” refers to a terminal that is physically portable by a user and includes at least one of a display, an audio output unit, a camera, and a microphone, and that is configured to send and receive data to and from the server.

The term “generative AI model” refers to a machine-implemented model for natural language generation or other content generation, which receives a sequence of tokens or features as input and outputs a sequence of tokens or features representing generated text or other media, based on parameters learned from training data.

The term “prompt sentence” refers to a structured sequence of tokens, including at least one instruction portion and at least one context portion, which is input to the generative AI model to cause the generative AI model to perform a specified operation such as answering a question, generating an explanation, or transforming text.

The term “context information” refers to information related to a current interaction with the user, including at least one of audio information, text information, location information, device setting information, time information, and previous interaction state information. The term “audio information” refers to data representing sound acquired from the user, including at least one of raw audio signals, compressed audio data, and feature data extracted from the audio signals.

The term “text information” refers to character data representing natural language input or output, including user-entered strings, transcription results of speech recognition, and text generated by the generative AI model.

The term “location information” refers to data indicating a geographic position, including at least one of coordinates, region identifiers, and area names, which is obtained from a positioning system or a network-based location service.

The term “device setting information” refers to information indicating an operational state or preference of the terminal, including at least one of user interface language, accessibility settings, notification settings, and communication parameters.

The term “route selection” refers to a process of determining, based on context information and analysis results, which processing pathway, task type, or back-end resource should be used for handling a given user input.

The term “data retrieval” refers to a process of obtaining reference data or candidate records from at least one storage device or external service, by executing a query or request based on context information and analysis results.

The term “reference data” refers to structured or semi-structured data used as a factual basis for generation by the generative AI model, including at least one of tourism records, daily-life guideline records, disaster-related manual records, product records, and service records.

The term “target domain” refers to a category or field of information for which a response or recommendation is to be generated, such as tourism, daily-life, disaster-related, product-related, or service-related domains.

The term “explanatory information” refers to text or other media that describes or clarifies an item, rule, or situation in a manner understandable by the user, based on reference data and user context.

The term “recommendation information” refers to text or other media that suggests items, actions, or options to the user, ranked or selected based on reference data, user context, and model output.

The term “emotion-related information” refers to data relating to an affective state of the user, including at least one of facial expression information, body posture information, voice characteristic information, and textual cues indicative of emotion.

The term “facial expression information” refers to image data or feature data extracted from image data that represents the user's face, including locations or shapes of facial components such as eyes, eyebrows, and mouth.

The term “voice characteristic information” refers to feature data extracted from audio information, such as pitch, intensity, speaking rate, spectral features, and prosodic patterns, used for inferring an emotional state.

The term “emotion state” refers to a classification result representing a psychological state of the user, such as joy, sadness, anger, anxiety, confusion, stress, or neutrality, obtained by processing emotion-related information.

The term “image processing” refers to computational operations applied to image data, such as detection, segmentation, feature extraction, and transformation, executed by the processor.

The term “machine learning processing” refers to computational operations executed by a trained model, such as classification, regression, or clustering, applied to input features in order to produce an inference result.

The term “emotion condition” refers to control information associated with an emotion state, specifying at least one of tone, detail level, and information type to be used for generating or formatting output for the user.

The term “tone” refers to a style or manner of expression used in output text or audio, including characteristics such as formality level, politeness level, and emotional nuance.

The term “detail level” refers to a degree of granularity or length of an explanation or answer, such as a concise summary, a standard explanation, or a detailed step-by-step description.

The term “information type” refers to a category of content to be emphasized or selected for presentation, such as safety-oriented information, encouraging information, overview information, or detailed procedural information.

The term “response data” refers to data output by the generative AI model in response to a prompt sentence, including at least generated text and, optionally, associated metadata.

The term “language checking” refers to a process of verifying that the response data is expressed in a desired natural language, and, optionally, conforms to a requested style or proficiency level.

The term “factual consistency checking” refers to a process of comparing factual statements in the response data with reference data, and detecting mismatches or inconsistencies.

The term “display-format adjustment” refers to a process of transforming response data into a format suitable for presentation on the terminal, including at least one of segmentation into sections, bulletization, and truncation.

The term “translation processing” refers to a process of converting text from a source language into a target language using at least one language translation algorithm or service.

The term “summarization processing” refers to a process of reducing the length of text while preserving essential information, using at least one summarization algorithm or model.

The term “restructuring processing” refers to a process of reorganizing the structure of text, such as reordering sentences, grouping related content, or changing a paragraph structure.

The term “presentation information” refers to information generated for output to the user, including at least one of text information, audio information, and image information derived from response data and emotion conditions.

The term “interaction history information” refers to data representing a sequence of past interactions between the user and the system, including at least question data, response data, timestamps, route selections, and emotion states.

The term “user evaluation information” refers to data representing feedback from the user regarding a response or interaction, including at least one of ratings, binary evaluations, and free-text comments.

The term “storage apparatus” refers to a memory device or a storage subsystem, such as a non-volatile storage unit or a database system, configured to store interaction history information, user evaluation information, and configuration data.

The term “configuration elements of the prompt sentence” refers to compositional components used to build a prompt sentence, including at least one of instruction templates, context templates, language specifications, and emotion annotations.

The term “routing conditions” refers to criteria used by the processor to select a processing route or task type, based on context information, analysis results, and interaction history.

The term “model control parameters” refers to settings used to control operation of the generative AI model, including at least one of decoding parameters, temperature, maximum output length, and domain-specific mode flags.

The server implements the invention as a network-connected computing apparatus including at least one hardware processor, a main memory, a non-volatile storage device, and a communication interface. The server operates under control of an operating system and executes application software modules written, for example, in a general-purpose programming language. The server communicates with at least one terminal operated by a user over a communication network.

The terminal implements a portable information terminal such as a smartphone, a tablet, or a wearable device. The terminal includes a display, a speaker, a microphone, a camera, a local storage, and a communication interface. The terminal executes client-side software that acquires user input, acquires sensor data including at least location information, facial images, and audio signals, and exchanges messages with the server.

The user operates the terminal to input questions, to set preferences such as a user interface language, and to grant or deny permissions to share sensor data including location and camera streams. The user perceives output from the terminal as text on the display, synthesized voice from the speaker, and optional graphical or multimedia content.

The server executes a group of cooperating functional modules including at least a context acquisition module, a speech recognition module, a language analysis module, a route selection module, a data retrieval module, a prompt construction module, a generative AI interface module, an emotion analysis module, a response post-processing module, a presentation generation module, and a feedback learning module. Each module is realized as executable software components that exchange data through in-memory data structures and persistent storage.

The server uses a generative AI model implemented as a neural network language model. The generative AI model has, for example, a transformer architecture including an input embedding layer, a plurality of self-attention layers, and a decoding layer. The generative AI model receives a prompt sentence as a token sequence and generates output token probabilities using self-attention over the entire sequence. The server runs the generative AI model either on a local accelerator device or via a remote inference service. The server provides model control parameters including at least a decoding temperature, a maximum output length, and top-k or top-p sampling thresholds to the generative AI model.

The server trains or fine-tunes the generative AI model using a corpus including question-answer pairs, explanatory texts, and dialog histories for multiple domains such as tourism, daily-life, disaster response, product information, and service information. The server uses a supervised learning procedure in which the generative AI model minimizes a cross-entropy loss between predicted token distributions and reference tokens. The server updates model parameters using a gradient-based optimization algorithm such as stochastic gradient descent with momentum or an adaptive algorithm. The server optionally performs data augmentation by paraphrasing training sentences, randomly masking words, and shuffling non-critical sentence segments to improve robustness. The server stores trained model weights in non-volatile storage and loads them into memory during inference.

The server implements the emotion analysis module using a neural network classifier. The server applies, for example, a convolutional neural network to facial images and a recurrent neural network or transformer to acoustic features extracted from voice signals. The server trains the emotion classifier on labeled datasets that map image frames and audio segments to discrete emotion labels such as joy, sadness, anger, anxiety, confusion, and neutrality. The server minimizes a classification loss function and updates classifier parameters using a gradient-based optimization algorithm. The server stores the trained parameters and uses them during runtime to classify emotion states.

The server uses specific data structures to represent context information. The server stores for each interaction an object including fields for user identifier (or anonymized session identifier), time stamp, device identifier, location coordinates, device setting information, raw user input text, transcribed audio text, language code, analysis results including intent, category, and extracted entities, and last known emotion state. The server stores this object in a volatile memory region while processing the interaction and persists summary records in a database.

The server uses, for example, a relational database system to store reference data. The server creates tables for tourism places, daily-life rules, disaster instructions, product attributes, and service descriptions. Each table includes fields for identifiers, textual descriptions, category tags, location tags, and other structured attributes. The server creates indices on frequently queried fields such as geographic coordinates and category tags to reduce query latency.

The server implements the prompt construction module such that the server programmatically generates prompt sentences as structured control artifacts rather than static template strings. The server constructs each prompt sentence by concatenating segments derived from templates and from context objects. The server uses explicit delimiters and labels such as “System:”, “Context:”, and “User question:” to separate segments. The server chooses templates based on route selection and emotion state. The server encodes all relevant technical constraints into the prompt, such as target language, required output format (for example, bullet list or step-by-step instructions), and factual constraints derived from the reference data.

The server generates, for example, a prompt sentence for explaining garbage separation rules as follows:
“You are an assistant helping foreigners in Japan. Answer in simple English. The user appears confused. Context: Garbage separation rules in Tokyo: 1) Burnable: kitchen waste, paper; 2) Non-burnable: metal items, ceramics; 3) Recyclables: glass bottles, cans, PET bottles. User question: ‘Please tell me how to separate garbage in Japan.’ Provide a clear, step-by-step explanation.”

The server generates, for example, a prompt sentence for tourism recommendations as follows:
“Generate a list of recommended sightseeing spots and restaurants near Tokyo Tower in Tokyo for a foreign tourist. Use simple English. Categorize them into ‘Sightseeing’, ‘Restaurants’, and ‘Events this week’. Here are the candidate places with basic data: [list of records].”

The server generates, for example, a prompt sentence for a product query as follows: “User question: ‘Is this product gluten-free?’ Product data: [ingredients list, allergen information]. Answer in the user's mother tongue. Clearly state whether the product is gluten-free and mention any important allergens.”

The server uses these prompt sentences to instruct the generative AI model to perform not only text generation but also structured integration of database results, explicit reasoning under factual constraints, and adaptation of tone and detail. The server ensures that the prompt always encodes the relevant configuration elements, including route selection results and emotion conditions.

The server uses a language analysis module that calls a language identification algorithm and a syntactic and semantic parser. The server detects the language of user input using, for example, a statistical classifier trained on character n-grams. The server parses the input using a dependency parser or transformer-based encoder and extracts intent labels and entities according to manually defined schemas. The server maps each input to one or more categories such as tourism, daily-life, disaster information, or product information. The server writes the analysis results into the context object.

The server uses a route selection algorithm that operates on the analysis results. The server defines a set of routing rules that compare intent labels, categories, and presence of location information against thresholds and priority values. The server uses, for example, a decision tree or a rule-based engine that selects a route identifier indicating which reference data sets and which templates the system will use. The server thereby avoids repeatedly invoking the generative AI model for unsuitable tasks, which reduces processing time and network usage. The server executes the data retrieval module after route selection. The server generates database queries with parameterized conditions derived from entities and location coordinates in the context object. The server shapes the results into normalized reference data structures that can be inserted into the “Context:” segment of the prompt sentence. The server uses specific selection criteria that filter out irrelevant or low-quality records. For example, the server discards product records whose allergen fields are incomplete, or discards tourism records that are outside a predefined distance range.

The server executes the emotion analysis module when the terminal transmits facial images or audio segments. The server applies image preprocessing operations including resizing, normalization, and face detection. The server passes face images through a convolutional neural network configured with multiple convolutional layers, pooling layers, and fully connected layers that output a probability distribution over emotion labels. The server similarly extracts acoustic features such as Mel-frequency cepstral coefficients from audio and feeds them into a neural network classifier. The server combines image-based and audio-based predictions using a weighted averaging scheme or a small fusion network. The server selects the emotion label with the highest probability and writes the label and confidence value to the context object.

The server converts the emotion label into an emotion condition. The server stores in a configuration table a mapping from emotion labels to preferred tone, detail level, and information types. For example, the server maps an anxiety label to a calm tone, a medium detail level, and safety-oriented information types. The server maps a confusion label to a neutral but highly detailed explanation and to additional clarifying examples. The server appends explicit instructions encoding these conditions to the prompt sentence, so that the generative AI model receives direct guidance on how to adjust output.

The server thereby changes internal behavior of the generative AI pipeline in a non-trivial way. Instead of merely presenting emotion information to a user interface, the server changes decoding parameters, target length estimates, and content selection instructions encoded in the prompt. This leads to reductions in unnecessary clarifying turns, which reduces total token consumption and model runtime.

The server executes the generative AI interface module by converting constructed prompt sentences into token sequences, passing them to the generative AI model, and receiving generated token sequences. The server configures the generative AI model to use context windows of sufficient length to hold all segments and employs decoding strategies adjusted to route identifiers. For example, the server uses lower temperature and constrained decoding for disaster information to increase determinism and factual repeatability, while using higher temperature for tourism recommendations to diversify suggestions. The server thereby alters the computational behavior of the generative AI model to suit each domain.

The server executes the response post-processing module on generated text. The server first checks the language of output using a language detector. When the detected language does not match the desired language, the server calls a separate translation service and replaces or corrects segments. The server then executes factual consistency checks by matching named entities in the generated text against reference data. The server rejects or corrects statements that contradict database fields. The server uses heuristics or rule-based filters to detect hallucinated locations or non-existent products. The server may perform a second generative pass with a verification prompt to correct such issues.

The server then transforms the validated text into a presentation-ready format. The server inserts line breaks and bullet symbols according to the requested output style, compacts or expands paragraphs to meet length constraints, and, when required, splits long answers into multiple screens. The server adds metadata specifying display roles such as title, subtitle, or body text, so that the terminal can map them to user interface components.

The server executes the presentation generation module to incorporate additional media. The server calls a speech synthesis service to generate audio waveforms from text. The server may select different voices or prosody profiles based on emotion conditions, such as a slower and calmer voice for users tagged as anxious. The server encapsulates text, audio, and image references into a response message and transmits it to the terminal via the communication interface.

The terminal receives the response and reconstructs the user interface presentation. The terminal reads the metadata and places titles, bullet lists, and notes in appropriate regions of the display. The terminal starts playback of audio data when requested. The terminal may overlay icons or color codes corresponding to emotion-aware content types, such as safety tips or positive news.

The server executes the feedback learning module to improve the computing system over time. The server records interaction history including prompt sentences, model outputs, route identifiers, emotion labels, and resource usage metrics such as latency and token counts. The server associates user evaluation information with these records. The server analyzes aggregated histories using statistical methods and machine learning to identify correlations between prompt configurations and evaluation scores. The server updates configuration parameters such as template wording, routing thresholds, and decoding parameters. The server thereby continuously refines the internal control of the generative AI model.

The server improves computer technology by implementing a control architecture in which prompt sentences become a machine-readable programming interface between application logic and generative inference. The server dynamically composes prompts based on structured context, emotion conditions, and historical performance metrics, rather than using static instructions. This yields several technical effects. First, the server reduces average and tail latencies by avoiding unnecessary multi-turn clarifications and mis-routed requests, because the server encodes precise intent and factual context into the prompt. Second, the server reduces computation cost and network traffic by preventing repeated or redundant calls to external services and by reusing context objects. Third, the server improves factual accuracy by cross-checking generated content against reference data and feeding factual constraints into the prompt. Fourth, the server stabilizes output style and language characteristics, which simplifies downstream formatting and decreases re-rendering costs at the terminal.

The server further improves technical performance by integrating emotion analysis into model control instead of only at the user interface. The server translates emotion classifications into explicit prompt properties and decoding parameters, resulting in output that is more likely to satisfy the user's needs in a single or fewer turns. This reduces the number of tokens processed by the generative AI model and lowers computational workloads on processors and accelerators.

The server performs processing that is not a mere automation of human mental tasks. A human operator cannot practically compute multi-modal features from image and audio streams, execute large-scale neural network inference, manage large reference databases, and dynamically optimize prompt configurations based on longitudinal interaction histories at the speed and granularity achieved by the server. The server relies on specific neural network architectures, loss functions, optimization algorithms, and data structures that are tied to the operation of computing hardware.

The server can adopt variant implementations. The server may run the generative AI model on a local accelerator using a deep learning framework, or may access an external inference service via an application programming interface. The server may store reference data in relational databases, document stores, or key-value stores. The server may use different neural network architectures for emotion analysis, such as graph-based networks or attention-based networks. The server may deploy additional safety classifiers that filter generated content before presentation.

The terminal can also implement variants. The terminal may perform part of the emotion analysis or speech recognition locally and send intermediate features instead of raw media, thus reducing bandwidth and preserving privacy. The terminal may cache frequently used presentation templates or partial responses to further reduce round-trip times.

The user can experience various use cases enabled by the system. The user can request translated disaster instructions and receive concise, verified procedures in their preferred language with a calm tone when anxiety is detected. The user can ask about product safety, and the system cross-checks product databases and generates a response that conforms to factual attributes. The user can explore tourism options and obtain categorized recommendations that take into account both location and emotional states such as excitement or fatigue.

These embodiments illustrate how the server, the terminal, and the user cooperate to implement the claimed system in a manner that results in concrete improvements in computing performance, data handling, and generative model control, thereby satisfying practical technical requirements and enabling others skilled in the art to carry out the invention.

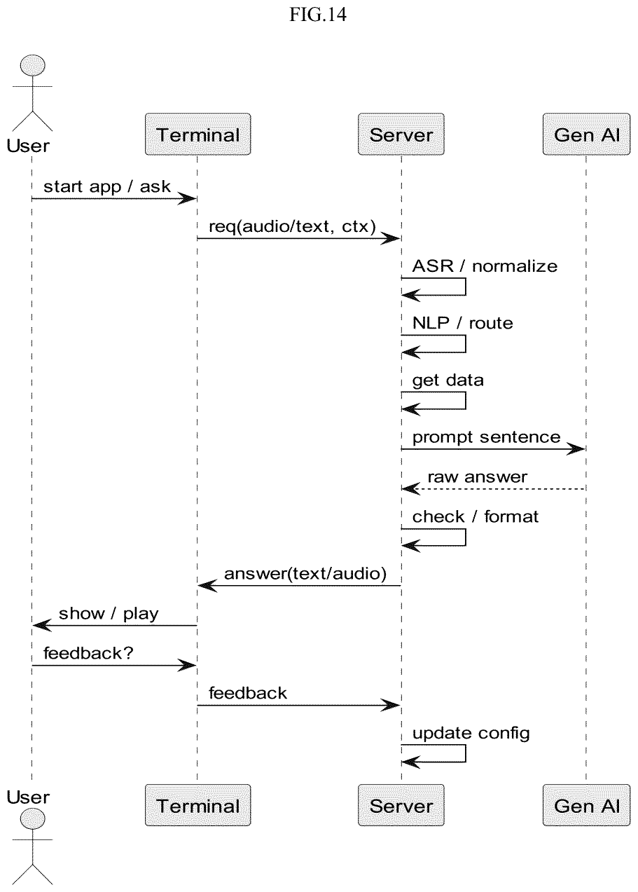

The following describes the processing flow using FIG. 14.

### Step 1:

The user operates the terminal to start an application and to provide an initial input.

The input is at least one of spoken utterance, typed text, location permission, and language preference.

The terminal displays an input screen, activates the microphone and keyboard, and acquires the spoken or typed question together with device setting information and, when permitted, location information from a positioning module.

The terminal outputs a structured request object that includes the raw audio data or text, current location coordinates, and user interface language, and transmits this object to the server via a communication interface.

### Step 2:

The server receives the request object from the terminal and normalizes the user input.

The input is the structured request object containing at least one of audio data, text data, location data, and device setting data.

The server checks whether the request contains audio data, and, when audio data is present, the server controls a speech recognition resource or an external speech recognition service to convert the audio waveform into text tokens, performing feature extraction (for example, spectrogram computation) and acoustic model inference; when only text data is present, the server skips the conversion.

The server outputs a normalized interaction record that includes a canonical text string representing the user question, the detected or specified language code, location data, and device settings.

### Step 3:

The server executes language analysis on the normalized interaction record.

The input is the canonical text string and associated metadata from the normalized interaction record.

The server applies a language detection algorithm to determine the language code, applies a tokenizer to split the text into tokens, and applies a parser or classifier to compute intent labels, category labels, and named entities by executing statistical or neural classification operations on token features.

The server outputs an enriched interaction record that includes intent, category, and entity fields populated based on the analysis.

### Step 4:

The terminal optionally acquires emotion-related sensor data under user permission.

The input is the user's action granting camera or microphone access within the application. The terminal activates the camera to capture facial images and activates the microphone to capture short audio segments, then packages these as emotion sensor data, optionally compresses or pre-processes them into feature vectors, and associates them with the current interaction identifier.

The terminal outputs an emotion data object and transmits it to the server.

### Step 5:

The server performs emotion analysis using the emotion data object.

The input is the emotion data object including facial images and audio segments or extracted features.

The server applies image processing (face detection, cropping, normalization) to the facial images and computes visual feature maps using a convolutional neural network, and the server computes acoustic features from the audio segments and classifies them using a neural classifier; the server fuses the visual and acoustic emotion probabilities to compute an emotion state label and a confidence score.

The server outputs the updated interaction record with an emotion_state field and an emotion_confidence field added.

### Step 6:

The server selects a processing route based on the enriched interaction record.

The input is the interaction record containing intent, category, entities, location, and emotion information.

The server evaluates routing rules or a decision model that compares the intent and category to pre-defined conditions, uses threshold comparisons on confidence values, and checks the presence of location data to determine whether to use a tourism route, a daily-life Q&A route, a disaster-information route, or a product-information route.

The server outputs a route identifier and attaches it to the interaction record.

### Step 7:

The server retrieves reference data associated with the selected route.

The input is the route identifier and the enriched interaction record including entities and location coordinates.

The server formulates database queries with conditions derived from entities (for example, place names, product identifiers) and range filters on coordinates, executes the queries on structured reference tables, and optionally calls external data services; the server then transforms the returned rows into normalized reference data objects containing only fields needed for generation.

The server outputs a reference data bundle that contains one or more domain-specific records linked to the interaction.

### Step 8:

The server constructs a prompt sentence for the generative AI model.

The input is the interaction record, the route identifier, the emotion state, and the reference data bundle.

The server selects a template corresponding to the route, programmatically fills template slots with system instructions, user question text, summarized reference data, target language information, and explicit emotion-based conditions (for example, desired tone and detail level), concatenates these segments with labels such as “System:”, “Context:”, and “User question:”, and encodes the result as a prompt sentence string.

The server outputs a finalized prompt sentence that will be passed as input to the generative AI model.

### Step 9:

The server executes generative inference using the generative AI model.

The input is the prompt sentence and associated model control parameters, including at least maximum token length and decoding temperature.

The server tokenizes the prompt sentence into model input tokens, forwards them to the generative AI model running either locally or via a model service, and causes the model to compute attention weights and probability distributions over next tokens; the server repeatedly samples or selects tokens according to the decoding strategy until a stop condition is met.

The server outputs a raw generated text sequence that constitutes preliminary response data.

### Step 10:

The server post-processes the raw generated response data.

The input is the raw generated text sequence and the reference data bundle.

The server performs language checking by applying a language detector, performs factual consistency checking by extracting named entities from the generated text and comparing them against the reference data fields, and, when mismatches or unsupported entries are found, performs correction by truncating or regenerating segments; the server further applies optional translation, summarization, and restructuring algorithms to enforce the requested language, length, and layout.

The server outputs validated and formatted response text together with metadata describing its structure.

### Step 11:

The server generates presentation information targeted to the terminal.

The input is the validated response text, the metadata, and the emotion state.

The server segments the text into title, body, and bullet sections based on metadata, selects or adjusts an audio synthesis profile (for example, speech rate and prosody) according to the emotion state, and controls a speech synthesis service to convert the text into audio data; the server then packages the text segments, optional audio data, and display hints into a response message object.

The server outputs the response message object and transmits it to the terminal via the communication interface.

### Step 12:

The terminal presents the response message to the user.

The input is the response message object including text sections, audio data, and display hints.

The terminal maps title and body segments to corresponding visual components on the display, renders bullet lists according to the display hints, and, when audio data is present and enabled, starts playback through the speaker; the terminal may also cache the response for local history.

The terminal outputs multimodal output signals that the user can see and hear as the final answer.

### Step 13:

The user optionally provides feedback and follow-up input.

The input is the presented answer and optional feedback controls shown by the terminal.

The user indicates satisfaction or dissatisfaction through buttons or ratings and, when necessary, enters a follow-up question in text or speech; the user's actions generate new feedback data and possibly new question content.

The terminal outputs a feedback object and, when a follow-up is entered, a new request object linked to the previous interaction identifier, and transmits these to the server.

### Step 14:

The server updates interaction history and learning data using the feedback.

The input is the feedback object and the stored interaction record including the original prompt sentence, generated response, route identifier, and emotion state.

The server writes the feedback to a history database, aggregates metrics such as helpfulness ratings and latency per route, and applies statistical analysis or training procedures to adjust configuration parameters, including prompt templates, routing thresholds, and decoding settings; the server thereby modifies internal tables and model-control metadata used for subsequent interactions.

The server outputs updated configuration state that influences future prompt sentence construction and generative AI model control.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

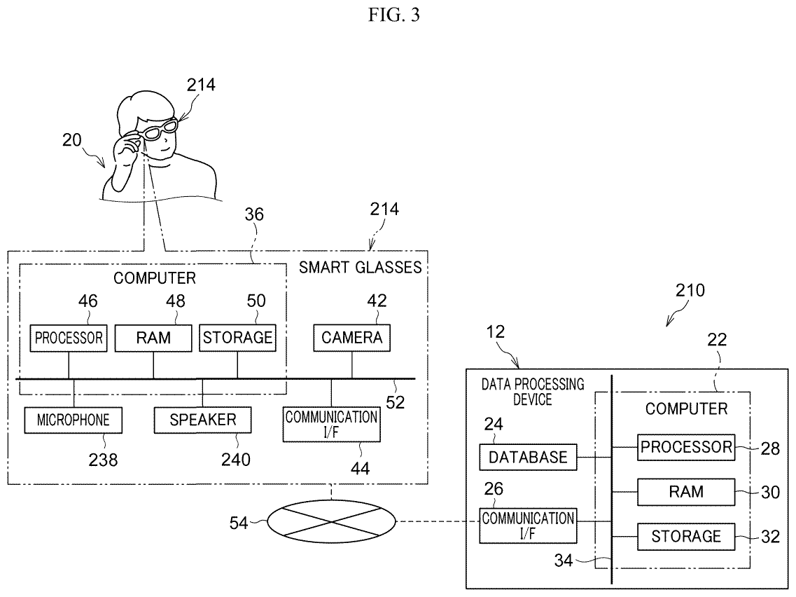

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

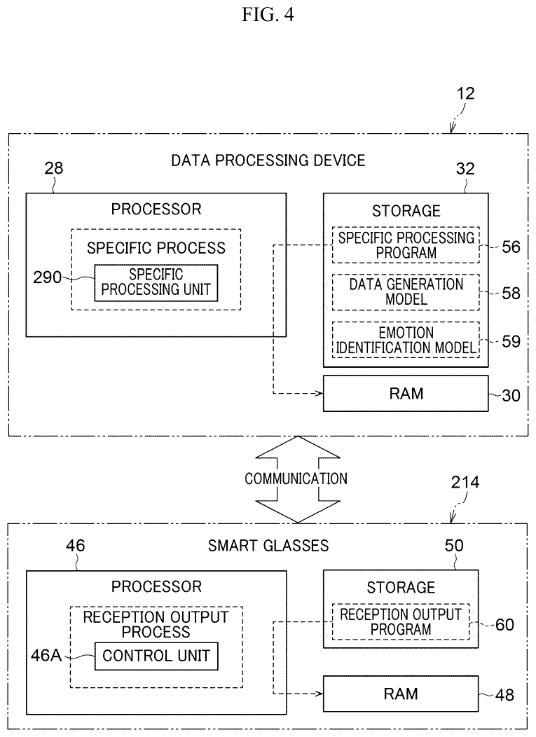

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

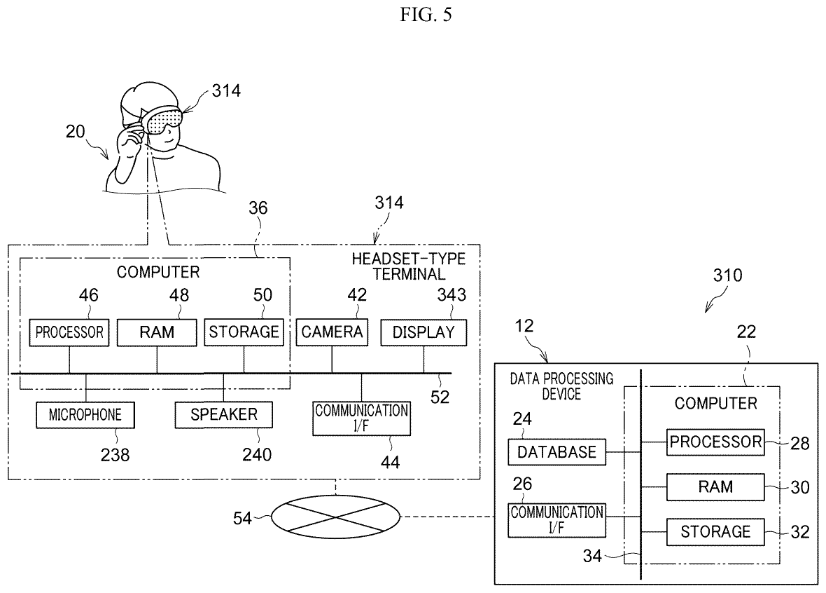

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

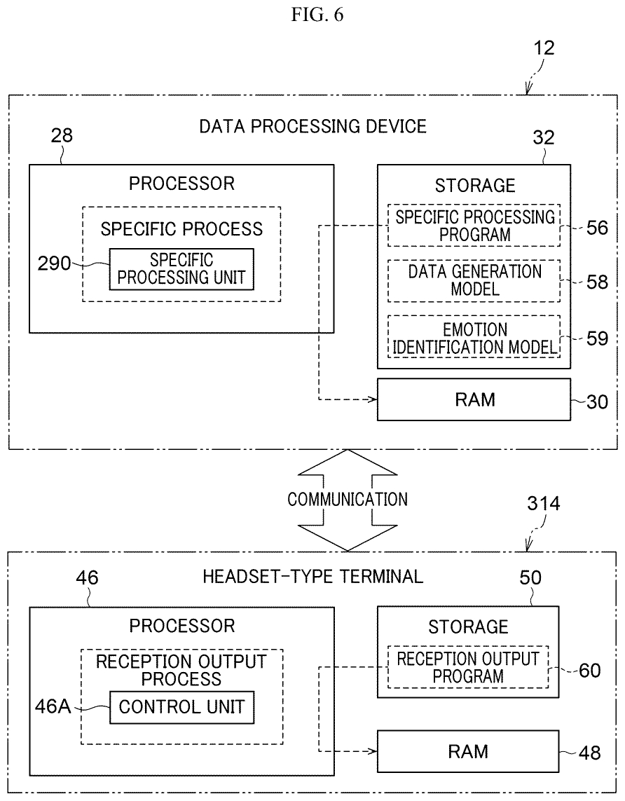

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

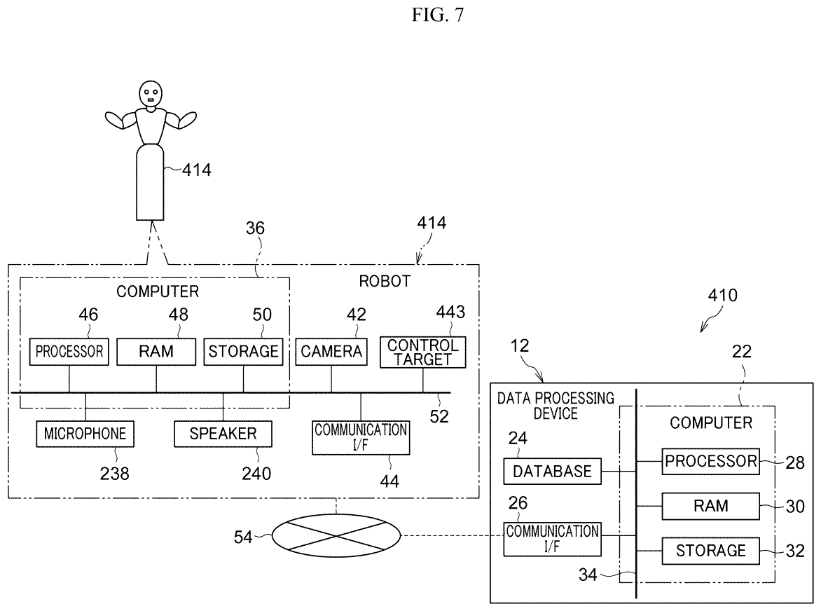

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

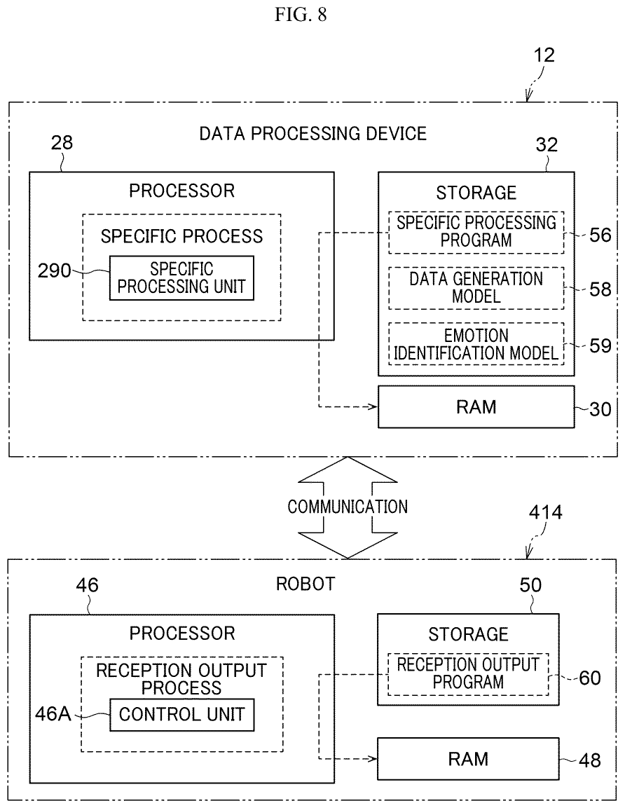

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

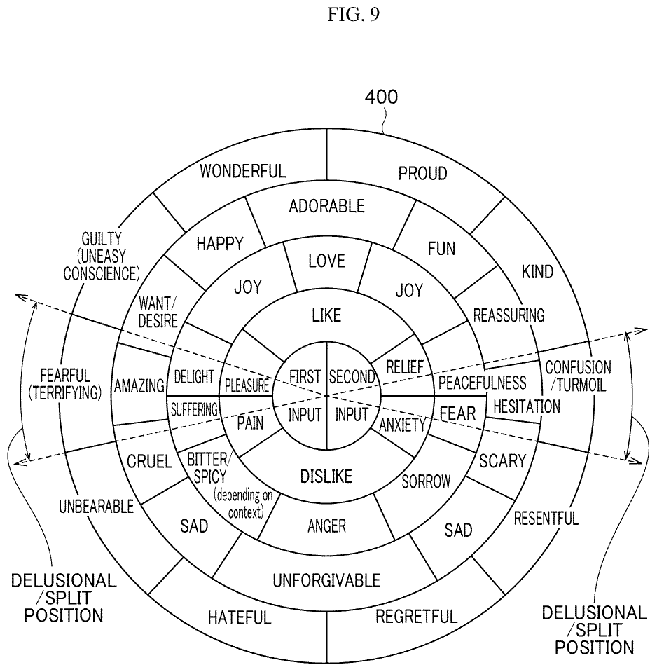

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

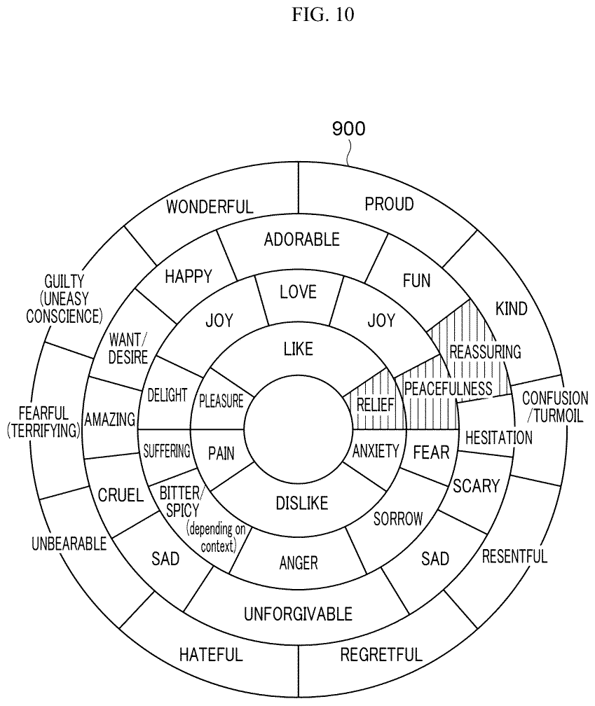

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to execute a program that controls processing for generating information for a foreign-language user by transmitting, to a generative AI model, an input sentence including a prompt sentence,
wherein the processor is configured to acquire original text information including news information or disaster-prevention information from a plurality of information-providing sources via a communication network, and to store the acquired original text information as structured data,
wherein the processor is configured to use translation software or an external translation service to convert character-string data in a first language included in the original text information into character-string data in at least one second language, and to store the converted character-string data in association with the original text information,
wherein the processor is configured to generate, as the input sentence to the generative AI model, a prompt sentence including evaluation criteria and classification criteria for the information-providing sources, to transmit the input sentence to the generative AI model, to receive an analysis result from the generative AI model, to calculate reliability of each information-providing source as a numerical value based on the analysis result, and to classify each information-providing source into a higher-level concept category including at least one of a disaster-prevention category, a health category, and an education category, and to store a classification result,
wherein the processor is configured to transmit, to a user terminal in response to a use request received from the user terminal, response data formatted according to a communication protocol, the response data including the character-string data in the at least one second language generated by the translation software or the external translation service, and information on the information-providing sources classified by the processor,
wherein the processor is configured to generate, as the input sentence to the generative AI model, a prompt sentence for instructing the generative AI model to perform question analysis and answer generation based on a user input sentence received from the user terminal, the original text information, and a classification result of the information-providing sources, to transmit the input sentence to the generative AI model, to receive an answer sentence output from the generative AI model, and to format the answer sentence as response data for the user terminal, and
wherein the processor is configured to generate, as the input sentence to the generative AI model, a prompt sentence for instructing the generative AI model to perform emotion analysis based on the user input sentence received from the user terminal, to transmit the input sentence to the generative AI model, to receive an emotion analysis result output from the generative AI model, and to control content or an expression format of information to be output in the response data based on the emotion analysis result.

### Supplementary 2

The system according to Supplementary 1,
wherein the processor is configured to extract, from among the original text information acquired by the processor, candidate information related to the use request received from the user terminal, to use the candidate information as context information, and to include the context information in the prompt sentence generated for the generative AI model so that the generative AI model refers to the candidate information in the answer generation processing.

### Supplementary 3

The system according to Supplementary 1,
wherein the processor is configured to attach, as metadata, a reliability value and category information calculated by the processor for each information-providing source, the metadata being referable within the prompt sentence generated by the processor, and to control the generative AI model so that the answer sentence output from the generative AI model includes reference information for an information-providing source having high reliability and belonging to a category corresponding to the use request.

### Application Example 1

### Supplementary 1

A system comprising a processor,
wherein the processor is configured to
acquire information data in a first language from a plurality of information providing sources via a communication network, normalize the information data as translation-target data, and store the translation-target data in a storage medium,
generate translation conditions including at least a target language, a target region, and an information type based on the translation-target data and user attribute data, construct a prompt sentence including the translation conditions as an instruction to a generative AI model, and cause the generative AI model to execute translation processing on the translation-target data to obtain a translation result,
determine, for disaster-related information data acquired from disaster-related information providing sources, disaster translation conditions including at least a disaster type, an occurrence region, an urgency level, and a target language, construct a prompt sentence including the disaster translation conditions as an instruction to the generative AI model, and cause the generative AI model to execute translation processing and simplification processing on the disaster-related information data to obtain a disaster translation result,
generate evaluation indices indicating at least reliability, relevance, and novelty of the plurality of information providing sources based on structured data relating to the plurality of information providing sources and evaluation criterion data acquired via the communication network, construct a prompt sentence including the evaluation indices and category information as an instruction to the generative AI model, and cause the generative AI model to evaluate the plurality of information providing sources and to select and categorize the plurality of information providing sources according to the reliability,
select, based on language settings, region settings, and notification settings for each user, at least one of the translation result and the disaster translation result, configure the selected result as notification data, and transmit the notification data to a terminal device via the communication network,
input acquisition data relating to the plurality of information providing sources to the generative AI model together with a prompt sentence including an editing instruction, cause the generative AI model to generate summary information, tag information, and explanatory information, and construct an index database of high-quality information providing sources based on at least the summary information,
receive a search request or a question sentence from the terminal device, extract related content corresponding to the search request or the question sentence from the index database as context information, construct a prompt sentence including the context information and the search request or the question sentence as an instruction to the generative AI model, cause the generative AI model to generate an answer sentence based on the context information, and transmit the answer sentence to the terminal device,
analyze operation history data, browsing history data, and notification response history data of a user to extract interest information of the user, select at least one of the translation result, the disaster-related information data, and the high-quality information providing sources based on the interest information, and generate and provide a personalized recommendation information list, and
receive, as a natural-language prompt sentence, at least one of notification conditions, translation conditions, and information acquisition conditions input by the user, analyze the prompt sentence to generate structured rule information including at least a language type, an information type, and an execution timing, and, based on the structured rule information, automatically execute, periodically or upon occurrence of an event, at least one of the translation processing, the disaster translation processing, and notification processing.

### Supplementary 2

The system according to supplementary 1,
wherein the processor is configured to
receive the question sentence from the terminal device, obtain context information by executing an information search process based on the question sentence, construct a prompt sentence including at least an answer policy, an output language, and a difficulty level of expression together with the context information as an instruction to the generative AI model, cause the generative AI model to analyze the question sentence and to generate an answer sentence based on the context information, and provide the answer sentence to the terminal device.

### Supplementary 3

The system according to supplementary 1,
wherein the processor is configured to
acquire input text data and operation history data of the user from the terminal device as analysis-target data, construct a prompt sentence including at least an emotion classification policy and an output format as an instruction to the generative AI model, input the analysis-target data to the generative AI model to cause the generative AI model to classify an emotional state included in the analysis-target data, select at least a part of the translation result, the disaster-related information data, and the personalized recommendation information list according to the emotional state, and provide a selection result to the terminal device.

### Example 2

### Supplementary 1

A system comprising a processor,
wherein the processor is configured to
receive a prompt sentence transmitted from a terminal that accepts user input and, in order to analyze a user intention, a location, a category, and constraint conditions included in the prompt sentence, cause a generative AI model, by using a prompt sentence that instructs the generative AI model to perform semantic analysis of the prompt sentence and conversion of the prompt sentence into structured search parameters, to analyze the prompt sentence, and identify a search category, a search target region, and search conditions based on an analysis result, and
acquire electronic document data from an information source obtained via a communication network by crawling the information source based on a predefined evaluation criterion and a keyword and retrieving the electronic document data, and
generate analysis data representing content and evaluation of the electronic document data by performing, for the electronic document data, natural language processing including language identification, syntactic analysis, keyword extraction, sentiment estimation, and named entity extraction, and
classify the electronic document data based on the analysis data by using upper-level concepts including categories of living information, tourist information, restaurant information, disaster-prevention information, and other categories, and attach tags including at least one of a place, a price range, a congestion level, and family suitability to the electronic document data, and
store the classified and tagged electronic document data in a data management structure on an information storage device in association with index information for search, and hold the classified and tagged electronic document data in a searchable state by the category, the place, the tag, and a language, and
search the stored electronic document data based on the search category, the search target region, and the search conditions obtained as the analysis result, and extract candidate information including foreigner-oriented information and disaster-prevention information required by the user, and
process the candidate information by causing the generative AI model, by using a prompt sentence that instructs the generative AI model to summarize the candidate information and to generate, in natural language, an explanation and recommendation information that are easy for the user to understand, to generate processed information, and transmit the processed information to the terminal, and
analyze the information source by causing the generative AI model, by using a prompt sentence that instructs the generative AI model to analyze the evaluation criterion of the information source, to analyze the information source, and determine a reliability and a category of the information source based on an analysis result.

### Supplementary 2

The system according to supplementary 1,
wherein the processor is configured to
analyze a question by causing the generative AI model, by using a prompt sentence that instructs the generative AI model to analyze question content and to generate structured answer candidates and supplementary explanations, to analyze the question, and generate user-oriented answer information by integrating a search result of the stored electronic document data with the answer candidates.

### (Supplementary 3)

The system according to supplementary 1,
wherein the processor is configured to
analyze a user emotion by causing the generative AI model, by using a prompt sentence that instructs the generative AI model to analyze the emotion of a prompt sentence and an input history acquired from the user, to analyze the emotion, and select the stored electronic document data based on a category and a tag corresponding to the emotion, and present foreigner-oriented information and disaster-prevention information in a form adapted to an emotional state of the user.

### Application Example 2

### Supplementary 1

A system comprising a processor,
wherein the processor is configured to
generate a prompt sentence for a generative AI model, the prompt sentence instructing the generative AI model to perform natural language processing, route selection, and data retrieval based on context information including at least one of audio information, text information, location information, and device setting information acquired from a user via a terminal,
generate a prompt sentence for the generative AI model, the prompt sentence instructing the generative AI model to generate at least one of explanatory information and recommendation information regarding at least one of tourism information, daily-life information, disaster-related information, product information, and service information, based on the context information and reference data including information items corresponding to a target domain, acquire emotion-related information including at least one of facial expression information and voice characteristic information of the user from the terminal, execute image processing and machine learning processing on the emotion-related information to classify an emotion state of the user, and add an emotion condition specifying at least one of tone, detail level, and information type corresponding to the emotion state to the prompt sentence as an instruction for adjusting an output format and an output content of the generative AI model, transmit the prompt sentence to the generative AI model as input data, acquire response data output by the generative AI model, and perform at least one of language checking, factual consistency checking, and display-format adjustment on the response data, including at least one of translation processing, summarization processing, and restructuring processing when necessary,
generate presentation information including at least one of text information, audio information, and image information based on the response data and the emotion state, and transmit the presentation information to a portable information terminal used by the user, and store interaction history information and user evaluation information in a storage apparatus, and update, based on the interaction history information and the user evaluation information, at least one of configuration elements of the prompt sentence, routing conditions, and model control parameters used for the generative AI model.

### Supplementary 2

The system according to supplementary 1,
wherein the processor is configured to
control a computation resource or an external speech recognition service to execute speech recognition processing on the audio information acquired from the user, convert the audio information into text information, perform, on the text information, at least one of intent extraction, category determination, and entity extraction of a question included in the text information, and include a result of the intent extraction, the category determination, and the entity extraction as preprocessing information in the prompt sentence so as to instruct the generative AI model to generate an answer based on the preprocessing information.

### Supplementary 3

The system according to supplementary 1,
wherein the processor is configured to estimate a temporal change of the emotion state of the user from the emotion-related information acquired over time, generate control conditions for controlling at least one of length, detail level, segmentation method, and presence or absence of additional proposals of an answer based on the temporal change of the emotion state, and input a prompt sentence including the control conditions to the generative AI model so as to acquire response data adapted to the temporal change of the emotion state of the user.

What is claimed is:

1. A system comprising:
circuitry configured to:
acquire, via a communication interface coupled to a packet-switched network, text data from a plurality of external data sources;
convert the text data from a first language representation to a second language representation by executing a translation module comprising a neural network model;
generate a prompt including evaluation criteria and classification instructions, and transmit the prompt together with the text data in the second language representation to a generative neural network model;
receive, from the generative neural network model, inference data including a reliability value computed for each of the plurality of external data sources and a category label assigned to each portion of the text data; and
transmit, via the communication interface and the packet-switched network, response data including the text data in the second language representation, the reliability value for each external data source, and the category label for each portion to a terminal device.

2. The system according to claim 1, wherein the circuitry is further configured to receive, from the terminal device via the communication interface, a query in the second language representation, generate a prompt for the generative neural network model to analyze the text data and generate an answer to the query, and transmit the answer to the terminal device via the communication interface and the packet-switched network.

3. The system according to claim 2, wherein the circuitry is further configured to include, in the prompt, context data selected from the text data based on a reliability threshold, such that the generative neural network model generates the answer based on text data from external data sources whose reliability value exceeds the reliability threshold.

4. The system according to claim 1, wherein the circuitry is further configured to apply an emotion classification model to at least one of the text data and sensor data received from the terminal device, and classify an emotional state into one of a plurality of emotion categories.

5. The system according to claim 4, wherein the plurality of emotion categories includes at least calm, worried, afraid, confused, and angry, and wherein the circuitry is further configured to select, based on the classified emotional state, at least one of a response tone, a vocabulary complexity level, and a content filtering threshold for the response data.

6. The system according to claim 5, wherein the circuitry is further configured to, when the classified emotional state is one of worried, afraid, or confused, simplify the text data in the second language representation by reducing sentence length and replacing technical terminology with simplified equivalents before transmitting the response data.

7. The system according to claim 1, wherein the category label is assigned from a set of higher-level concept categories including at least disaster prevention, health, education, daily life, and immigration, and wherein the circuitry is further configured to organize the text data in the second language representation according to the assigned category labels.

8. The system according to claim 7, wherein, when the category label is disaster prevention, the circuitry is further configured to convert the text data into a simplified disaster notification including at least a disaster type, an occurrence region, and an urgency level, using a specialized conversion process that prioritizes brevity and clarity in the second language representation.

9. The system according to claim 1, wherein the circuitry is further configured to store, in a storage device, an index database including, for each of the plurality of external data sources, a plurality of evaluation indices comprising at least a reliability index, a relevance index, and a novelty index, and to compute the reliability value based on a weighted combination of the evaluation indices.

10. The system according to claim 9, wherein the circuitry is further configured to generate, for each portion of the text data, a summary and a set of tags using the generative neural network model, and store the summary and the tags in the index database in association with a source identifier of the corresponding external data source.

11. The system according to claim 10, wherein the circuitry is further configured to receive a search query from the terminal device, retrieve entries from the index database based on a similarity between the search query and the stored tags and summaries, and generate an answer to the search query using the generative neural network model with the retrieved entries as context.

12. The system according to claim 1, wherein the circuitry is further configured to store, for the terminal device, a preference profile including at least a preferred language, a geographic region, and notification settings, and to filter and prioritize the response data based on the preference profile before transmitting to the terminal device.

13. The system according to claim 12, wherein the circuitry is further configured to analyze a behavior history of an operator of the terminal device, the behavior history including at least previously accessed categories and interaction timestamps, and to adjust the filtering and prioritization of the response data based on the behavior history.

14. The system according to claim 1, wherein the circuitry is further configured to receive, from an administrator terminal, a natural-language instruction specifying a processing rule, and convert the natural-language instruction into a structured rule comprising at least a language type condition, an information type condition, and an execution timing condition using the generative neural network model.

15. The system according to claim 1, wherein the generative neural network model comprises a transformer-based neural network including an embedding layer that maps discrete tokens to multidimensional vector representations, a sequence of self-attention layers each computing scaled dot-product attention over query, key, and value matrices, feed-forward layers, and an output projection layer, and wherein the translation module comprises a sequence-to-sequence neural network.

16. The system according to claim 4, wherein the sensor data includes at least one of image data representing a facial expression of an operator of the terminal device and audio data representing voice characteristics of the operator, and wherein the emotion classification model performs multi-modal analysis on the sensor data to classify the emotional state.

17. The system according to claim 1, wherein the circuitry is further configured to accumulate interaction history data including at least operator queries, selected categories, and reliability feedback, and to periodically update, based on the interaction history data, at least one of a prompt configuration, a routing rule, and a model parameter of the generative neural network model.

18. A system comprising:
circuitry configured to:
acquire, via a communication interface coupled to a packet-switched network, text data from a plurality of external data sources, each external data source associated with a structured record in a storage device, the structured record including at least a source identifier, a language identifier, and a reliability index;
convert the text data from a first language representation to a second language representation by executing a translation module comprising a sequence-to-sequence neural network that references a translation table mapping linguistic units between the first language and the second language;
generate a prompt including evaluation criteria and classification instructions referencing a set of higher-level concept categories including at least disaster prevention, health, education, daily life, and immigration, and transmit the prompt together with the text data in the second language representation to a generative neural network model;
receive, from the generative neural network model, inference data including a reliability value for each external data source and a category label for each portion of the text data, and, when the category label is disaster prevention, convert the corresponding portion into a simplified disaster notification including a disaster type, an occurrence region, and an urgency level;
receive, from a terminal device via the communication interface, a query in the second language representation, generate a context-based answer by providing the generative neural network model with the query and context data selected from the text data based on the reliability value, and transmit the answer to the terminal device; and
transmit, via the communication interface and the packet-switched network, response data including the text data in the second language representation, the reliability value, the category label, and any simplified disaster notifications to the terminal device.

19. The system according to claim 18, wherein the circuitry is further configured to apply an emotion classification model to at least one of the query and sensor data received from the terminal device, classify an emotional state of an operator into one of a plurality of emotion categories including at least calm, worried, afraid, confused, and angry, and adjust at least one of a content complexity level and a response format of the answer and the response data based on the classified emotional state.

20. A method performed by a system comprising circuitry, the method comprising:
acquiring, via a communication interface coupled to a packet-switched network, text data from a plurality of external data sources;
converting the text data from a first language representation to a second language representation by executing a translation module comprising a neural network model;
generating a prompt including evaluation criteria and classification instructions, and transmitting the prompt together with the text data in the second language representation to a generative neural network model;
receiving, from the generative neural network model, inference data including a reliability value computed for each of the plurality of external data sources and a category label assigned to each portion of the text data; and
transmitting, via the communication interface and the packet-switched network, response data including the text data in the second language representation, the reliability value for each external data source, and the category label for each portion to a terminal device.
